(19) United States
(12) Patent Application Publication
(10) Pub. No.: US 2012/0069165 A1
(43) Pub. Date: Mar. 22, 2012

(54) LOCATION-BASED AV FLASHLIGHT AND METHOD OF DISPLAYING MAP RELATED VIDEO THEREOF

(76) Inventors: Seung-lyul CHOI, Seoul (KR); Hyung-ja SUNG, Seoul (KR)

(21) Appl. No.: 13/233,945

(22) Filed: Sep. 15, 2011

(30) Foreign Application Priority Data
Sep. 16, 2010 (KR) KR2010-0091230
Nov. 8, 2010 (KR) KR2010-0110386
Aug. 5, 2011 (KR) KR2011-0078233

(51) Int. Cl. H04N 7/18

(52) U.S. Cl. 348/61; 348/E07.085

(57) ABSTRACT

An audio and video (AV) flashlight has a head portion, a body portion and a rear portion. Mounted on the head portion is a video camera module incorporating a visible light source and an infrared light source. Mounted on the body portion are a GPS module, an electronic compass module, a display module, a map database module, and a control module to read map information from the map database within a predetermined angle range with reference to an azimuth angle detected through the electronic compass module, display the read information on the display module, and display current location information and current location information of one or more main objects in a forward direction along with linear distance information to the current location. The flashlight enables relative measuring of distance with an eye with respect to a monitoring object based on the linear distance information of the main objects.

### CROSS-REFERENCE TO RELATED APPLICATIONS

This application claims priority from Korean Patent Application Nos. 10-2010-0091230, filed on Sep. 16, 2010, 10-2010-0110386, filed on Nov. 8, 2010, and 10-2011-0078233, filed on Aug. 5, 2011, in the Korean Intellectual Property Office, the disclosure of which is incorporated herein by reference in its entirety.

### BACKGROUND

1. Field of the Invention

The invention relates to a flashlight and a method of displaying map-related video thereof, and more particularly, to a location-based AV flashlight which records geographical location information of the portable flashlight on the move and is capable of video recording, and a method of displaying a map-related video thereof.

2. Description of the Related Art

Flashlights are widely used as emergency lights on sites where lighting is necessary. Developments of high brightness and light efficiency, longer lifespan and low power-consuming LED light source and batteries have further extended a range of flashlight use.

As the LED flashlights employing LED light sources have been distributed, flashlight with audio and video recording functions (hereinafter, ‘AV flashlight’) have recently been introduced.

U.S. Pat. No. 7,646,973 and US Patent Publication No. 2006-0171700 disclose a flashlight combined with a camera system. The above-mentioned references mainly disclose a technology of providing a manual rotation filter on a lens to satisfy both visible ray mode and infrared light mode.

Korean Patent Publication No. 2000-017113 and related U.S. Pat. No. 6,451,515, Korean Patent Publication No. 2004-058381 and US Patent Publication No. 2005-0018044 disclose a technology of RF-transmitting an image signal captured at an AV flashlight.

US Patent Publication No. 2005-0018044 and US Patent Publication No. 2009-0066504 disclose a technology of RF transmitting location information of an AV flashlight using an embedded GPS receiver.

In addition to a basic lighting function, the AV flashlight now has an increased number of functions to provide, including the functions of recording video and audio signals or RF transmitting or transmitting location information.

Meanwhile, the introduction of the multi-functioned AV flashlights and convergence of the state-of-the-art electronic technologies have necessitated more complicated structure of internal components and properties such as shock-resistance, anti-corrosiveness, and air-tightness have also been increasingly demanded.

One of the widely-known distance measuring technologies that can be applied to flashlight is to emit laser or ultrasound wave, receive reflective wave and accordingly measure the distance. However, while such ‘laser-type’ is easy to install due to compactness and arrangement in parallel with light source, since the angle of reception narrows at remote distance, this can be used only within a limited range which is several tens of meters. Further, the ‘laser-type’ can be exposed easily especially at night due to light emitted therefrom. The ‘ultrasound-type’ can hardly be installed in combination with the light source due to structural limit of an ultrasound-receiving equipment, and distance measurement thereof is influenced by the ambient noise especially severely (which practically disables distance measurement) when this is used to measure at remote distance that is farther than 50 m.

Further, the flashlights need to be water-proof and air-tight beyond general degrees, to be able to give light and also photograph the site in rains, under rivers or sea. Particularly in under-water setting, the flashlights have to have sufficient ruggedness to resist water pressure. The AV flashlights also have shortcoming that the operation button formed thereon is often pressed by water pressure at predetermined depth of water.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

According to one embodiment, a technical objective is to provide a location-based audio and video (AV) flashlight with shock-resistance, high water-proofness and air-tightness, which can be used almost weather-proof in anywhere.

Another objective is to provide a location-based AV flashlight which can record a video signal in combination with security and patrol tracking information based on location information.

Yet another objective is to provide a location-based AV flashlight which can display on a real-time basis a reference distance to help measure with an eye a distance to a specific object at a front direction within a photographing range without requiring a distance measuring sensor such as laser or ultrasound sensor and based on the current location information.

Yet another objective is to provide a location-based AV flashlight which can search a video signal which is recorded based on geographical information (location and azimuth angle).

Yet another objective is to provide an AV flashlight which can improve GPS signal receptivity of a GPS receiving module.

Yet another objective is to provide a method of displaying map-related video, according to which it is enabled to see the video photographed by an AV flashlight along with map data.

Yet another objective is to provide an AV flashlight which is waterproof at 100 m depth of water, and also can record sound at 24 mm depth of water.

Yet another objective is to provide an AV flashlight which has an addition of AV function that may increase circuit complexity, but also has a disassemblability and thus can provide improved productivity.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a perspective view of an AV flashlight in assembled state according to a first embodiment;

FIG. 2 is a plan view of an AV flashlight according to the first embodiment;

FIG. 3 is a perspective view of the AV flashlight in disassembled state according to the first embodiment;

FIG. 4 is a view illustrating a body portion of the AV flashlight in enlargement according to the first embodiment;

FIG. 5 is a block diagram of the AV flashlight according to the first embodiment;

FIG. 6 is a detailed block diagram of the control module of FIG. 5;

FIG. 7 is a view illustrating an example of a keypad of the AV flashlight according to the first embodiment;

FIG. 8 is a view illustrating a main menus screen displayed on a display module;

FIGS. 9 to 22 are views illustrating the screens displayed on the display module of the AV flashlight according to the first embodiment;

FIG. 23 is a view illustrating an initial screen of a PC view program;

FIGS. 24 to 26 are views illustrating the screens to explain PC view operation;

FIG. 27 is a perspective view of an AV flashlight in assembled state according to a second embodiment;

FIG. 28 is a front view of the AV flashlight according to the second embodiment;

FIG. 29 is an exploded perspective view of a head portion of the AV flashlight according to the second embodiment;

FIG. 30 is a cross-section view of the head portion of the AV flashlight in assembled state according to the second embodiment;

FIG. 31 is an exploded perspective view of a body portion of the AV flashlight according to the second embodiment;

FIG. 32 is a cross-section view of a body portion of the AV flashlight in assembled state according to the second embodiment;

FIG. 33 is an exploded perspective view of a rear portion of the AV flashlight according to the second embodiment;

FIG. 34 is an exploded view of a rear portion combined with a supplementary battery in the AV flashlight according to the second embodiment;

FIG. 35 is a perspective view of an AV flashlight in assembled state according to the third embodiment;

FIG. 36 is an exploded perspective view of the head portion of FIG. 35;

FIG. 37 is an exploded perspective view of lens barrel of FIG. 35;

FIG. 38 is a schematic view illustrating the keypad module and the GPS receiving module of FIG. 37;

FIG. 39 is a side view illustrating the AV flashlight according to the third embodiment;

FIG. 40 is a schematic view of an external connect terminal portion provided at the first lens barrel;

FIG. 41 is a perspective view illustrating an example where a plastic cap is used for the external connect terminal portion of FIG. 40;

FIG. 42 is a perspective view illustrating an example where a waterproof microphone is used for the external connect terminal portion of FIG. 40;

FIG. 43 is a cross-section view illustrating an example where the waterproof microphone of FIG. 42 is installed on the external connect terminal portion;

FIG. 44 is a plan view illustrating the AV flashlight according to the third embodiment;

FIG. 45 is a plan view illustrating the board housing of FIG. 37;

FIG. 46 is a cross-section view taken on line I-I of FIG. 44;

FIG. 47 is a cross-section view illustrating portion B of FIG. 46 in enlargement;

FIG. 48 is a bottom view illustrating the board housing of FIG. 37; and

FIG. 49 is an exploded perspective view of the rear portion of FIG. 35.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

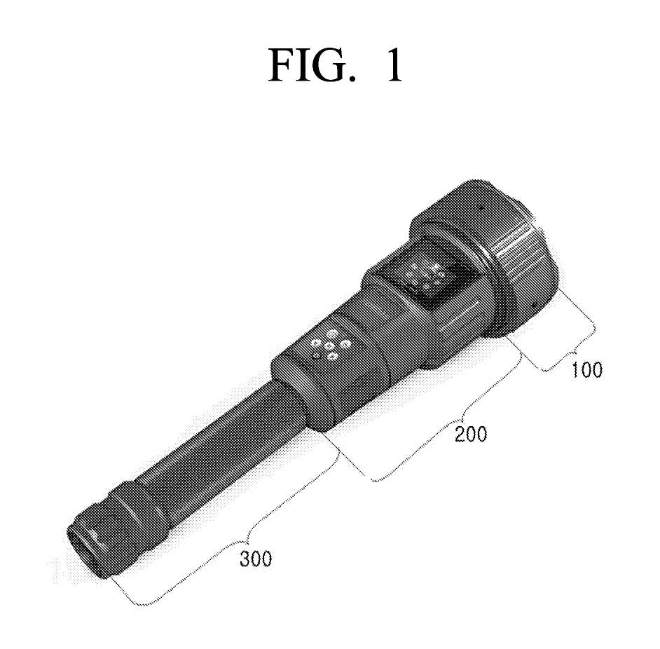

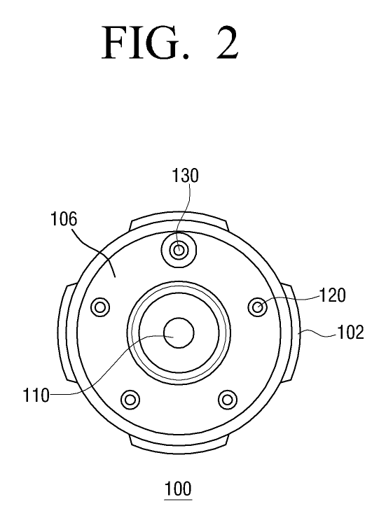

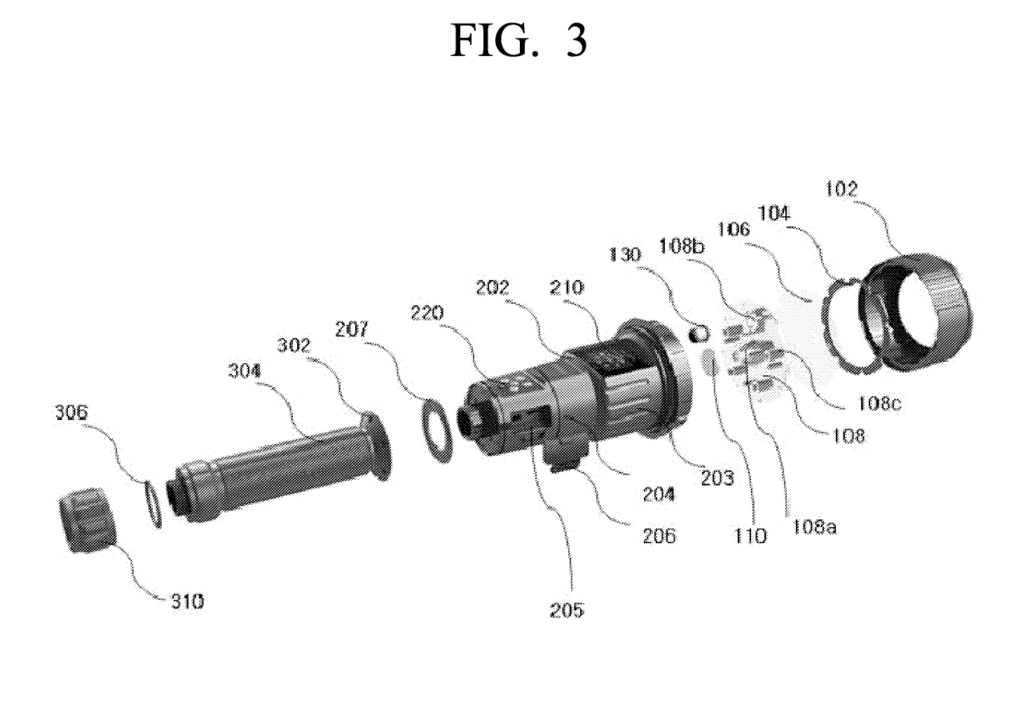

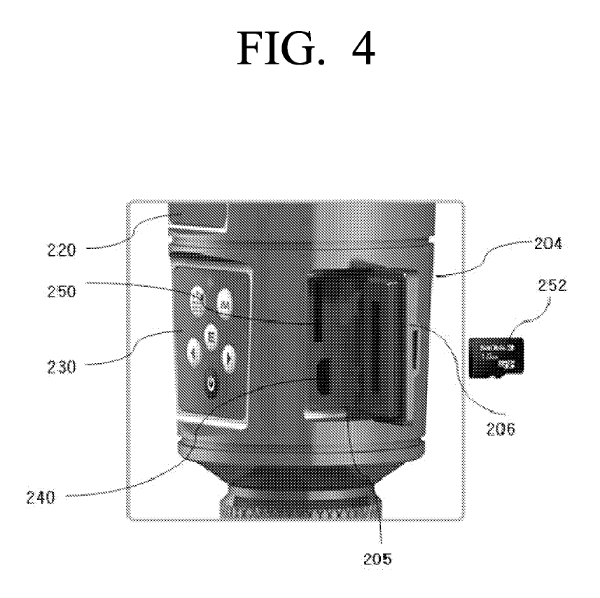

Referring first to FIGS. 1 to 4, the AV flashlight according to a first embodiment may mainly include a head portion 100, a body portion 200, and a rear portion 300.

The head portion 100 may include an O ring 104, a circular light-transmitting plate 106 and a reflective plate 108 mounted on an inner side of a leading end of a head lens barrel 102 which has the largest outer diameter. The circular light-transmitting plate 106 may be made from a high strength transparent glass (e.g., pylex glass) which provides 97% light transmission and 30 m water resistance. A funnel-shaped recess 108a may be extended at a center of the reflective plate 108 in a direction from the front to the back, and a visible light source 110 is engaged with an end of the funnel-shaped recess 108a. An inner inclined surface of the funnel-shaped recess 108a may be treated into a reflective layer to reflect the light emitted from the visible light source 110 in a forward direction. One video camera module mounting hole 108b and four infrared light source holding holes 108c may be arranged at uniform intervals in proximity to the funnel-shaped recess 108a. The visible light source 110 may include high brightness white LED diode (e.g., 150˜450 Lm white LED module, Cree), and the four infrared light sources 120 may include infrared LED diodes.

The reflective plate 108 may be screw-engaged with the inner side of the leading end of the head lens barrel 102 to maintain complete waterproof state at 30 m depth of water.

The video camera module 130 may implement a fixed-focus method and include a lens module and FULL HD CMOS image sensor, and an infrared shutter of the lens module which is arranged on a light receiving path of the CMOS image sensor. The infrared shutter passes only the infrared ray in infrared light mode, i.e., in infrared mode (night vision mode), but moves out of the light path to pass the visible light in the visible light mode. The rear end of the video camera module 130 may be engaged with the light receiving portion of the CMOS image sensor. The CMOS image sensor may be, for example, 1/2.5 inch Full HD image sensor (ST9P001) of Micron.

The body portion 200 is a double-structure lens barrel 202 which may have a smaller diameter than the head lens barrel and larger outer diameter than the rear portion 300. The head lens barrel 102 may be screw-engaged with the leading end of the body portion 200. A mounting hole may be formed on an outer surface of an upper side of a first structure 203 of the body portion 200, so that 1.5″ liquid crystal display module 210 is mounted thereon. Likewise, a mounting hole may also be formed on an outer surface of an upper side of a second structure 204 of the body portion 200, so that a GPS module 220 and a keypad 230 are mounted thereon.

A recess 205 may be formed on an outer circumference of one side of the second structure 204 of the body portion 200, with an entrance of the recess 205 covered by a cover 206 to be protected from the external atmosphere. A signal connect jack 240 and an external memory card slot 250 may be formed inside the recess 205. The signal connect jack 240 meets the specification of the high-definition multimedia interface (HDMI) connector including three video signal terminals (YPbPr) and stereo audio terminal (Audio L&R). USB 2.0 connector specification is also possible.

The memory card slot 250 meets 128 MB Built-in Flash Memory/mini SD card support SDHC, 32 GB max specification. TF card (Micro SD card) 252 may be mounted in the memory card slot 250.

A circuit board (not illustrated) may be mounted inside the body portion 200. A control module 400 on which a control circuit and a power circuit are mounted may be formed on the circuit board to receive electricity from rechargeable battery and generate operating voltages for respective components, and control the display module 210, GPS module 220, keypad 230, signal connect jack 240, memory card slot 250, video camera module 130, visible light source 110, or infrared light source 120.

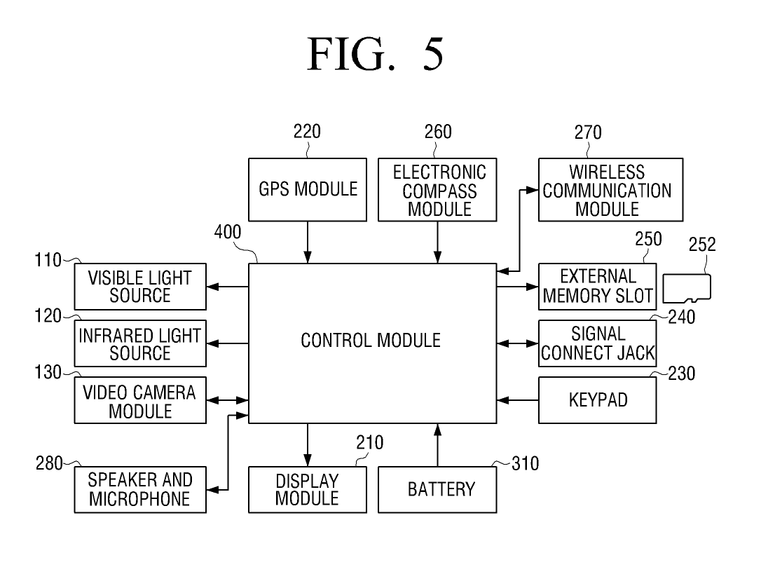

An electronic compass module 260, a wireless communication module 270, and a speaker and a microphone 280 (see FIG. 5), or the like may be housed within the body portion 200. The wireless communication module 270 may be provided as an option.

The rear end of the body portion 200 may be fixedly engaged with a leading end flange 302 of the rear portion 300 by a plurality of screws and with the intervention of the O ring 207 to maintain waterproofness at 30 m depth of water.

The rear portion 300 may be implemented as a rear lens barrel 304 having such an outer diameter to enable convenient grip. An outer circumference of the rear portion 300 is knurled and provided as a handle. A rechargeable battery may be housed inside the rear portion 300, and with the intervention of the O ring 306 of a rear cap 310, the rear end of the rear portion 300 is screw-engaged with the rear end of the rear lens barrel 304. The battery may be implemented as a 18650 lithium ion battery, and can be used up to 4.5 hours maximum when used only for lighting purpose, or up to 3.5 hours maximum when used for both lighting and video recording. The head lens barrel 102, the double-structure lens barrel 202 and the rear lens barrel 304 constructed in the manner explained above may be made from aircraft aluminum T6062 processed with automatic lathe into 340 mm of length, 98 mm of maximum diameter, and 750 g of weight, which is quite portable.

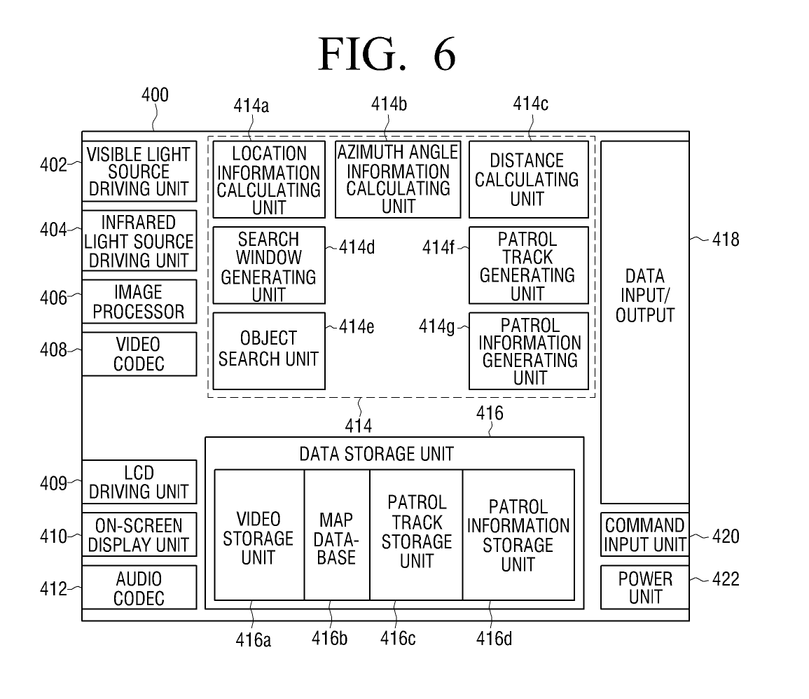

Referring to FIGS. 5 and 6, the control module 400 controls on/off and brightness of the LED visible light source 110 and the LED infrared light source 120 through a visible light source driving portion 402 and an infrared light source driving portion, and if receiving a video signal from the video camera module 130 through an image processor 406, carries out video compression by H-264/MPAG4 and controls the infrared shutter mounted on the video camera module in response to the photographing mode.

The control module 400 displays image and text data on the display module 210 through an LCD driving portion 409 and an on-screen display portion 410, and carries out audio compression of an audio signal inputted from the speaker and the microphone 280 by HQ ACC through an audio codec 410.

The control module 420 may send out the video and audio data compressed through a data input/output 418 via the wireless communication module 270, store video and audio data in a removable memory element 252 such as TF (micro SD card) flash memory card (storing 32 GB up to 16 hours maximum) via the external memory slot 250, directly display video data on a television or a monitor through the signal connect jack 240, or upload the video and audio data to PC by USB 2.0 protocol or download map database from the PC.

The control module 400 may include a central control unit 414 including a microprocessor or a micro computer chip, and a data storage unit 416 including volatile memory device such as DDR DRAM and ROM, EEPROM or flash memory device.

The central control unit 414 may include a location information calculating unit 414a, an azimuth angle information calculating unit 414b, a distance calculating unit 414c, a search window generating unit 414d, an object searching unit 414e, a patrol track generating unit 414f, and a patrol information generating unit 414g.

The location information calculating unit 414a receives satellite information from the GPS module 220, calculates current location and generates current location information.

The azimuth angle information calculating unit 414b receives two- or three-axis earth magnetic field information from an electronic compass module 260 and calculates azimuth angle information from the true north direction where the flashlight currently emits light.

The distance calculating unit 414c calculates distance information between the current location information and an object.

The search window generating unit 414d generates a search window in equilateral triangle shape which includes a predetermined angle (e.g., 45 degrees) to the left and right sides of the azimuth angle calculated at the azimuth angle calculating unit 414b. The ‘search window’ herein may be limited within a maximum angle of view of the video camera module 130 which photographs video.

The object searching unit 414e searches location information of an object previously registered on the map database within the range of the search window. The location information found by the search is provided to the distance calculating unit 414b.

The patrol track generating unit 414f generates track information on time axis of the current location information, and the generated patrol track is associated with the map database.

The patrol information generating unit 414g generates patrol area and patrol pattern information in combination with the direction of the search window with reference to the patrol track.

The data storage unit 416 may include a video storage unit 416a, a map database 416b, a patrol track storage unit 416c and a patrol information storage unit 414d.

The video storage unit 416a stores video files captured through the video camera module. The stored video files may be searched according to file name, time of photographing, patrol paths, or azimuth angles.

The map data of the patrolled area is established in the map database 416b, and the map data may be constructed by downloading for example, Google map data. Further, location information (longitude and latitude information) about main objects of the patrol area may also be registered on the map database 416b. The data of the map database 416b may be updated to the latest data via the wireless communication module 270 or the signal connect jack 240.

The patrol track storage unit 416c stores patrol track information generated at the patrol track generating unit 414f. Herein, the patrol track information may include patrol car, time of beginning (or ending) patrolling, patrol path, or azimuth angle information.

The patrol information storage unit 414d stores patrol information generated at the patrol information generating unit 414g. The patrol information is associated with the patrol track, and includes information such as patrol direction, track information of the equilateral triangular search window, or patrol range.

The power unit 422 receives electric voltage from the battery and provides the constant voltage to the respective components. The operating voltage may use low voltage such as 1.8V, 2.5V or 2.8V.

The respective blocks inside the control module 400 are mutually connected to internal bus to exchange data and control signals.

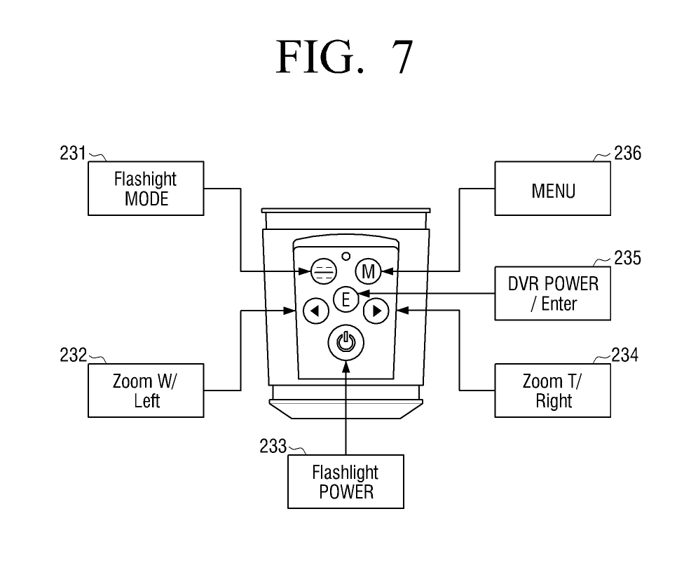

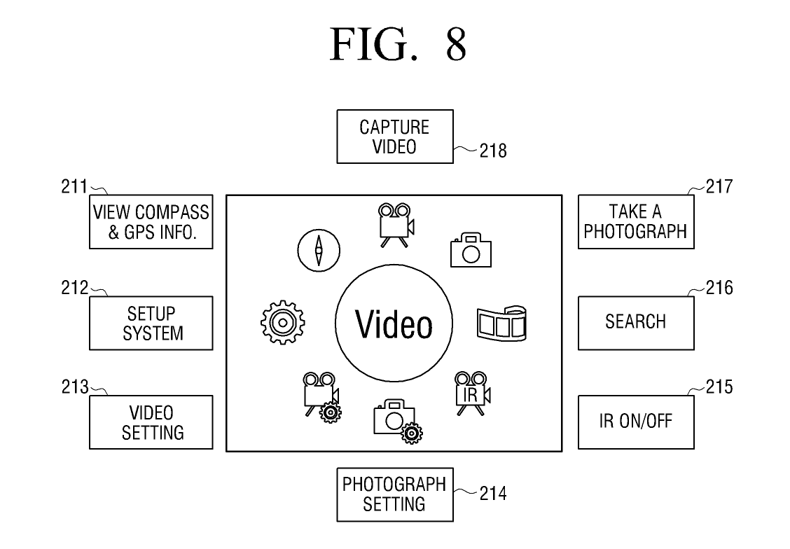

Referring to FIGS. 7 and 8, the keypad 230 may include a flashlight mode key 231, a left-side direction key 232, a power key 233, a right-side direction key 234, an enter key 235, and a menu key 236.

The flashlight mode key 231 selects four flashlight lighting modes including 30%, 50%, 100% and turn-off. Accordingly, it is possible to select among the four modes in sequence by pressing the mode key 231 once each time.

The left-side direction key 232 and the right-side direction key 234 control digital zooming during video recording.

The power key 233 is a flashlight on/off control key.

The enter key 235 and the menu key 236 are function keys used in association with the screen.

If the menu key 236 is pressed, the main menu screen of FIG. 8 appears on the liquid crystal screen on the display module 210. The main menu screen may include functions such as viewing compass and GPS information 211, setting system 212, video setting 213, photograph setting 214, IR on/off 215, searching 216, taking a photograph 217, or capturing video 218.

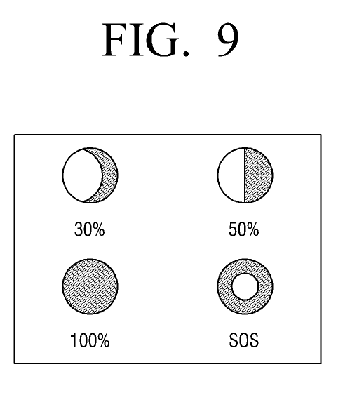

FIGS. 9 to 22 illustrate screen on the liquid crystal screen, and the operation of the location-based portable AV flashlight according to an embodiment will be explained below with reference to FIGS. 9 to 22.

1. Adjusting Brightness in Flashlight Mode

On pressing the power key 233, the flashlight by the visible light source 110 is turned off with 50% brightness as a base brightness. If a user presses on the enter key 235 longer to turn off DVR power and thus control the brightness of the flashlight, main menu of FIG. 8 appears. As the user presses brightness select key 231 in such a situation, brightness adjust menu as the one illustrated in FIG. 9 appears on the screen. The user may then select the brightness using left/right direction keys 232, 234 and confirm the intended brightness using the enter key 235. The flashlight turns off as the user presses the enter key 235.

2. Taking Video

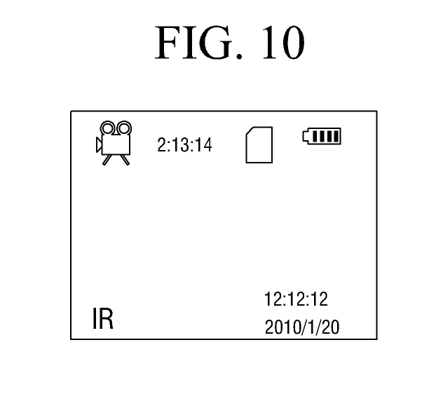

As the user presses the enter key 235 long enough to turn off the DVR power, the main menu of FIG. 8 appears. The user selects a video menu using the left/right direction keys 232, 234, confirms the selected menu using the enter key 235, and then presses again the enter key 235 in response to which video and audio recording starts with the recorded screen of FIG. 10 being displayed through the video camera module 130 and the speaker and microphone 280. The recording stops when the user presses the enter key 235 once again. The user may adjust digital zoom using the left/right direction keys 232, 234 during recording. If the recording is stopped, the user may switch to the main menu screen of FIG. 8 by pressing the menu key 236. The DVR power turns off when the user presses the enter key 235 long enough.

3. Taking a Photograph

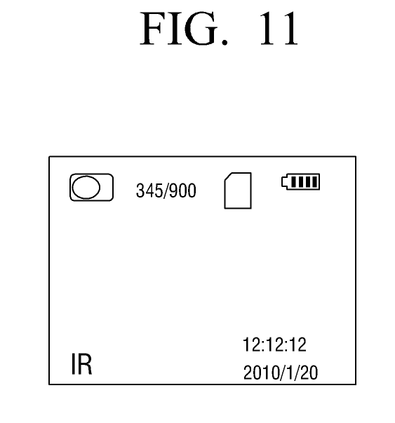

As the user presses the enter key 235 long enough to turn off the DVR power, the main menu of FIG. 8 appears. The user selects a photograph menu on the main menus screen and confirms the selection using the enter key 235. Accordingly, the photograph screen of FIG. 11 appears and the user is able to take photographs by pressing the enter key 235. The user may adjust zoom using the left/right direction keys 232, 234 and the screen changes to the main menu screen as the user presses the menu key 236.

4. Infrared (IR) Function

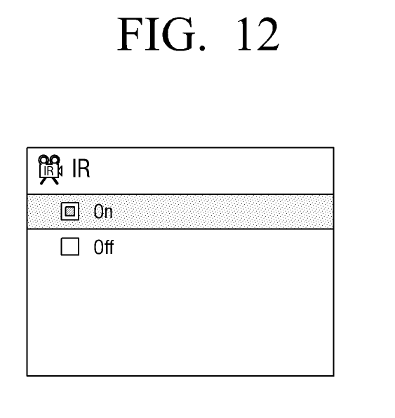

As the user presses the enter key 235 long enough to turn off the DVR power, the main menu of FIG. 8 appears. The user selects the IR menu 215 on the main menu screen and confirms the selection by the enter key 235. Accordingly, the IR on/off select screen as the one illustrated in FIG. 12 appears. The user selects on/off using the left/right direction keys 232, 234, and presses the enter key 235 so that the screen changes to the main menu screen after on/off function is completed.

5. System Setup

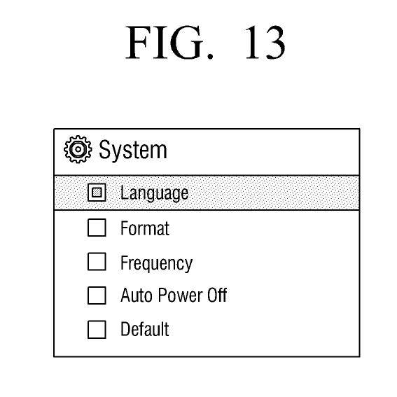

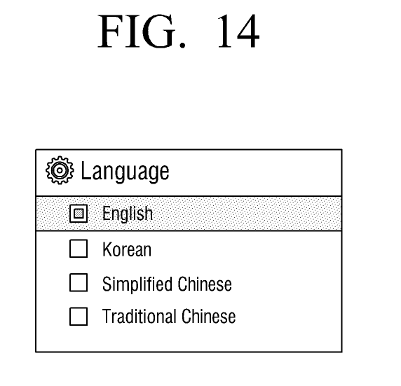

As the user presses the enter key 235 long enough to turn off the DVR power, the main menu of FIG. 8 appears. As the user selects the system setup menu 212 using the left/right direction keys 232, 234 on the main menu screen, the system setup screen as the one illustrated in FIG. 13 appears. The items of system setup may include display language, time setup, default, format, or automatic power-off. As the user selects ‘display language’ using the left/right direction keys 232, 234 and presses the enter key, the language select screen as the one illustrated in FIG. 14 appears. The user may move to the upper menu by pressing the enter key.

6. Photograph Setting

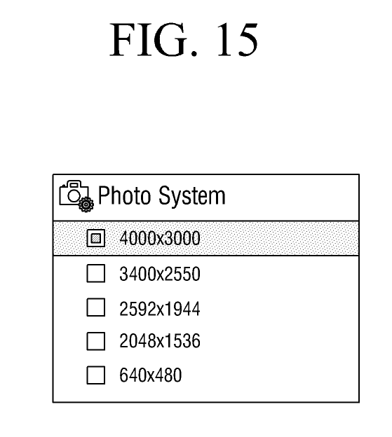

As the user presses the enter key 235 long enough to turn off the DVR power, the main menu of FIG. 8 appears. A photograph size select screen as the one illustrated in FIG. 15 appears as the user selects the photograph setting menu 214 on the main menu screen using the left/right direction keys 232, 234. The user selects ‘photograph size’ using the left/right direction keys 232, 234 and sets the photograph size based on the selected photograph size by pressing the enter key.

7. Video setting

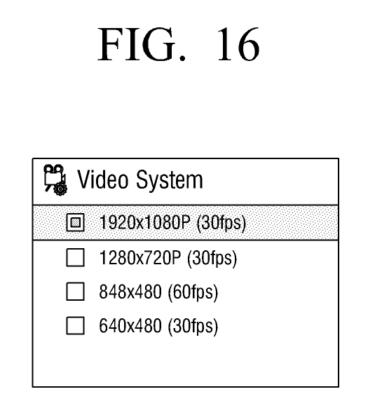

As the user presses the enter key 235 long enough to turn off the DVR power, the main menu of FIG. 8 appears. A video resolution select screen as the one illustrated in FIG. 16 appears as the user selects the video setting menu 213 using the left/right direction keys 232, 234 on the main menu screen. The user selects ‘video resolution’ using the left/right direction keys 232, 234 and sets the video resolution based on the selected resolution by pressing the enter key.

8. Viewing GPS Information

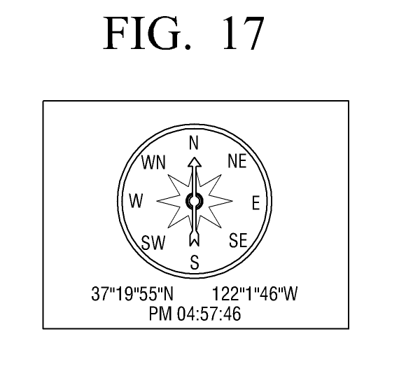

As the user presses the enter key 235 long enough to turn off the DVR power, the main menu of FIG. 8 appears. GPS information viewing screen as the one illustrated in FIG. 17 appears as the user selects the GPS information viewing menu 211 on the main menu screen using the left/right direction keys 232, 234. The azimuth angle of the photographing direction of the flashlight with respect to the true north on the compass appears on the screen (the azimuth angle is at zero on the drawing), while the current location information in the form of longitude and latitude and the current time information are displayed on a bottom.

9. Search

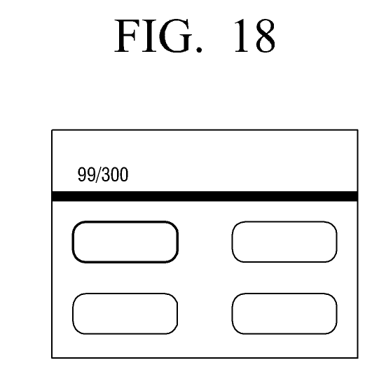

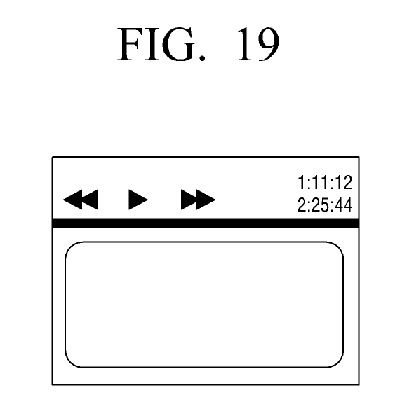

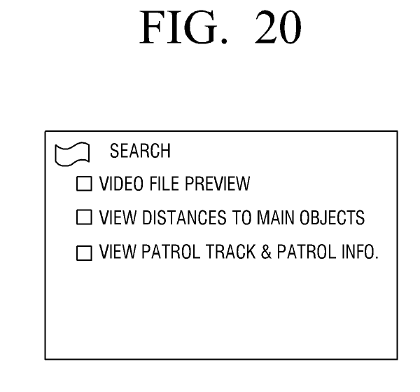

As the user presses the enter key 235 long enough to turn off the DVR power, the main menu of FIG. 8 appears. A search menu screen as the one illustrated in FIG. 18 appears as the user selects the search menu 216 using the left/right direction keys 232, 234 on the main menu screen. The user selects an intended search menu using the left/right direction keys 232, 234 from among the menus of ‘video file preview’, ‘viewing distances to main objects’, ‘viewing patrol track and patrol information’. As the user selects the ‘video file preview’ and presses the enter key, the video file select screen as the one illustrated in FIG. 19 appears. Then as the user selects a video file using the left/right direction keys 232, 234 and presses the enter key, a replay screen of the selected file appears as illustrated in FIG. 20. If the user presses the enter key during replay, the replay is paused. The user may also select to fast forward or fast rewind using the left/right direction keys 232, 234. The screen changes to the video file select screen of FIG. 19 if the user presses the menu key 236.

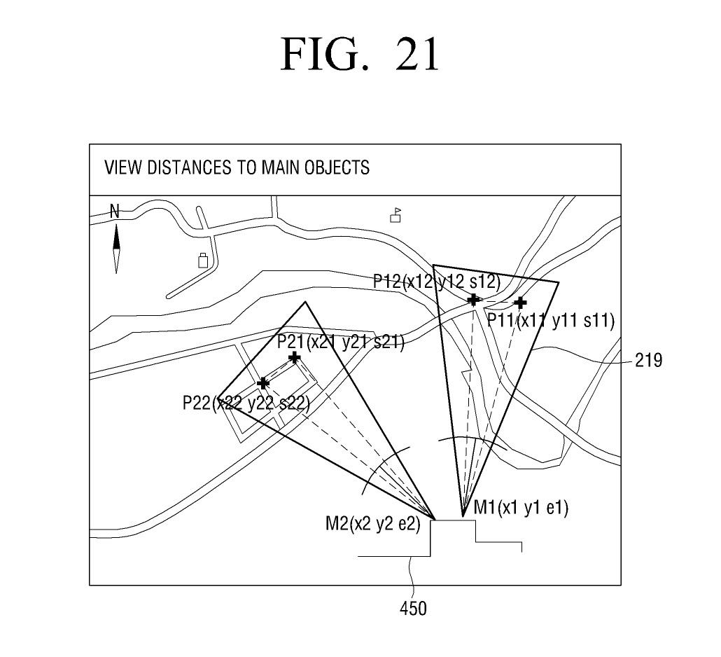

If the user selects the function of ‘viewing distances to main objects’ and presses the enter key, a main object distance view screen as the one illustrated in FIG. 21 appears regarding the area which is the subject of the monitory photographing. Referring to FIG. 21, the longitude and latitude information (x11, y11, s11) and (x12, y12, s12) of site P11 (i.e., a town office) and site P12 (i.e., intersection) and distance information (s11) from the current location M1 (x1, y1, 1) on the patrol path 450 appear on the map.

If the user turns the direction of the flashlight in the preview state, the search window changes to the same direction as the flashlight is turned, thereby displaying the location and distance information of the main registered objects included in the changed search window.

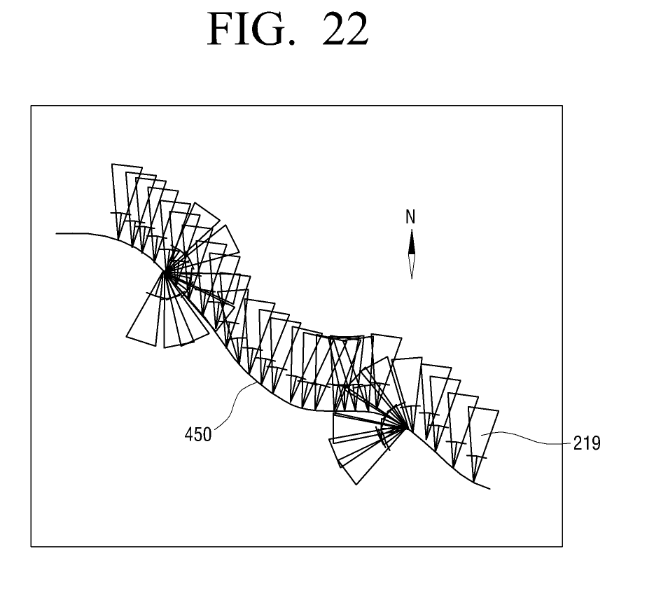

On the screen illustrated in FIG. 18, if the function of ‘viewing patrol track and patrol information’ is selected and the enter key is pressed, the patrol track and patrol information view screen as the one illustrated in FIG. 22 appears. Referring to FIG. 22, the direction and range of patrolling are indicated for notice of the user according to a periodical indication of the equilateral triangular search window which follows the patrol track 450 on the subject area of monitory photographing. As illustrated, the patrol pattern of a patroller may be analyzed in which the patroller patrols the north direction as the main patrol direction and photograph-scans on at least two sites within a range of approximately 180° between north and south directions.

10. PC View

A TF card (Micro SD card) 252 inserted in the external memory card slot 250 may store PC view program. The TF card (Micro SD Card) 252 stores photographed images. In order to view the images stored in the TF card (Micro SD Card) 252 on a personal computer (PC), the PC view program embedded in the TF card (Micro SD Card) 252 is installed on the PC.

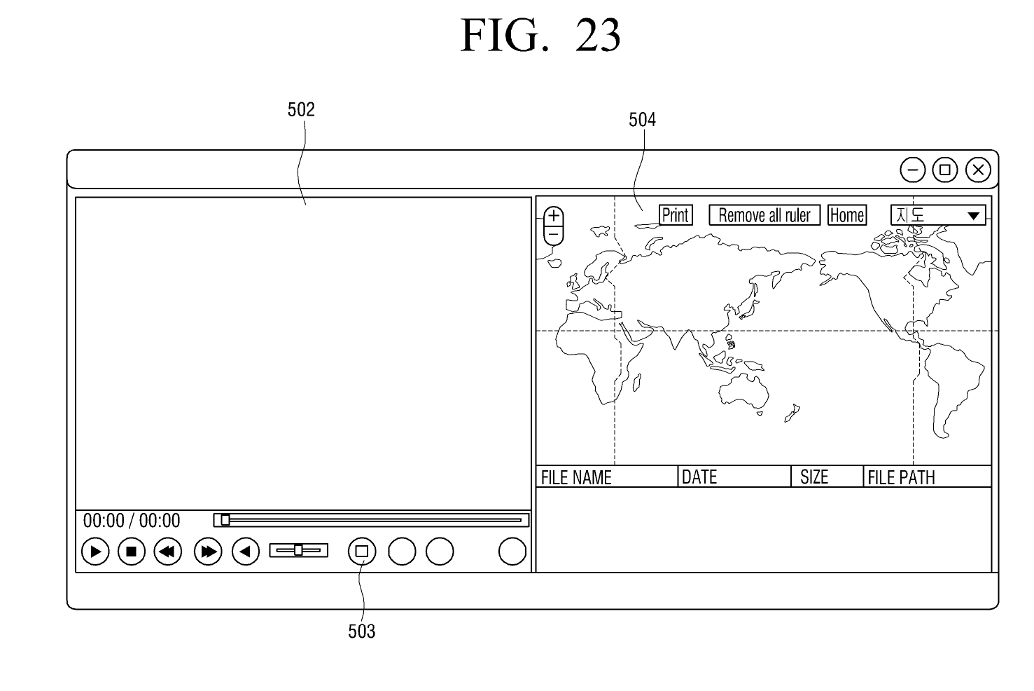

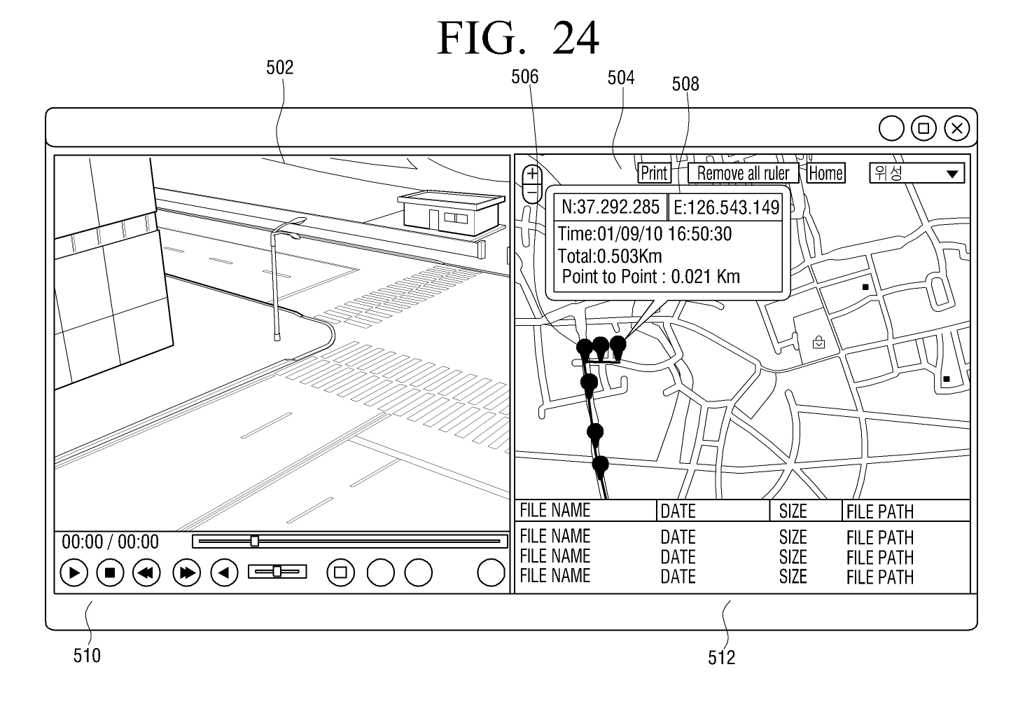

FIG. 23 illustrates the initial screen of the PC view program, and FIGS. 24 to 26 illustrate the screens to explain the PC view operation.

The initial screen includes a video screen 502 and a map screen 504.

If the user clicks on a file search button 503, and selects and confirms MP4, TXT (GPS information), the video of the corresponding file (PICT0001) is replayed on the screen 502. On the map screen 504, the map information corresponding to the GPS information of the TXT is displayed in a manner as illustrated in FIG. 24 in association with the Google map.

Upon beginning of the video replay, a blue balloon pin 505 is indicated on a starting point on the map screen 504. A red balloon pin 506 is also marked at predetermined intervals to indicate a path of travel 507.

If the user clicks on the red balloon pin 506 on the map screen 504, information indication 508 including the location information (including longitude and latitude), time, distance from the starting point, or distance to a previous location pin of the corresponding site appears. A file name 510 of the replayed video appears on a left-bottom direction of the video screen, and a total distance of the path of travel appears on a right-bottom direction of the map screen.

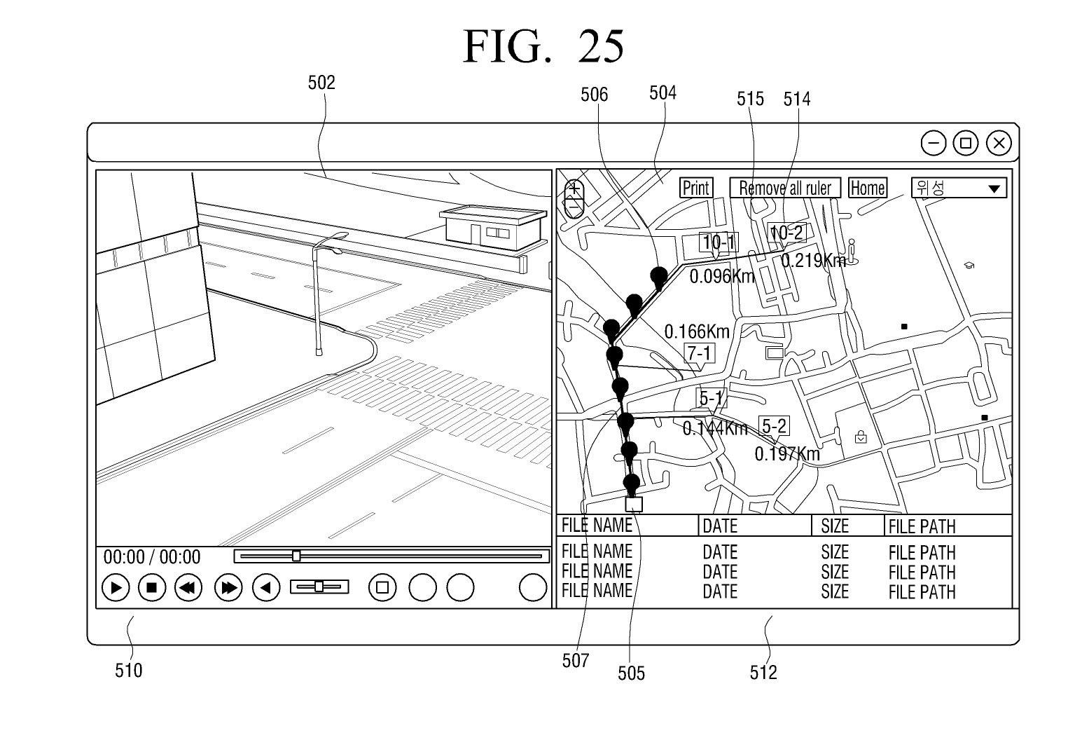

A plurality of yellow balloon pins 514 as the ones illustrated in FIG. 25 may be generated to confirm an error distance and measure a predetermined distance if the map screen 504 contains a deviation of location information on the map. The user may click on the location pin 506 with a right-side button of the mouse, and as the yellow balloon pins 514 appear, move to an intended site by pressing with a left-side of the mouse. Further, a green path 515 is generated as the user drags the mouse from the location of the red balloon pin 506, and then if the user designates a predetermined location, the yellow balloon pin 514 appears and the distance value appears on the map. As a result, the user is able to see a distance from the location of the red balloon pin 506 to the predetermined point with convenience. Since the user can instantly generates the yellow balloon pin 514 on the map screen on the left side if he or she wishes to know the distance to, for example, a building in the replayed video, the patroller is able to replay the images photographed in the path of patrol and easily analyze the distances to the landmarks on and around the patrol path.

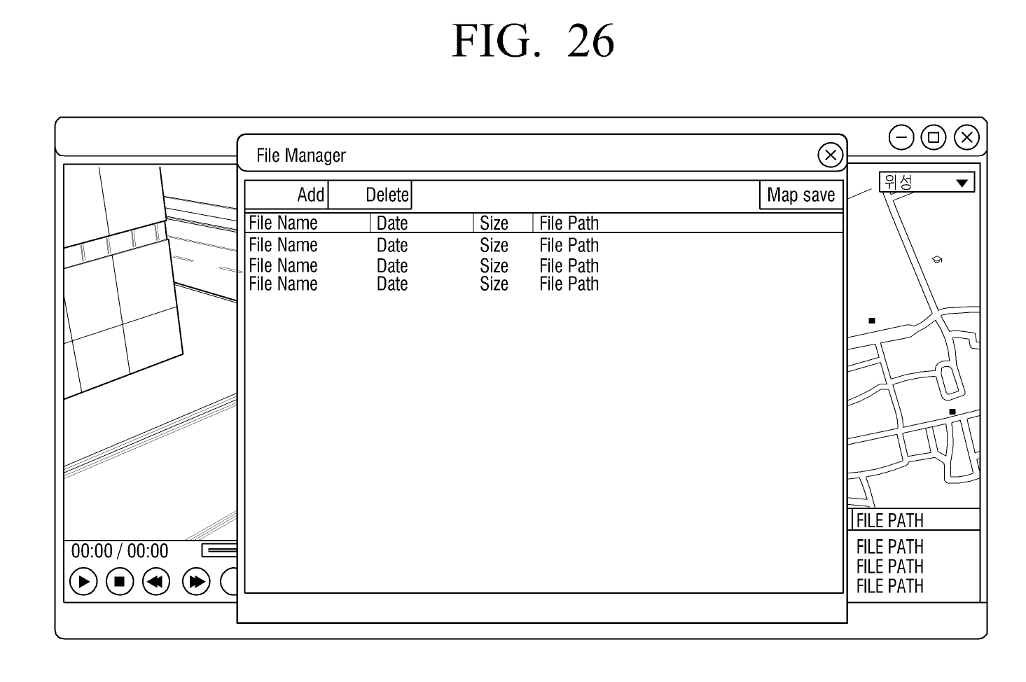

The location and distance information obtained with respect to a predetermined point on the map screen may be stored as an updated file (PICT0001_{—}1) on a corresponding file as illustrated in FIG. 26.

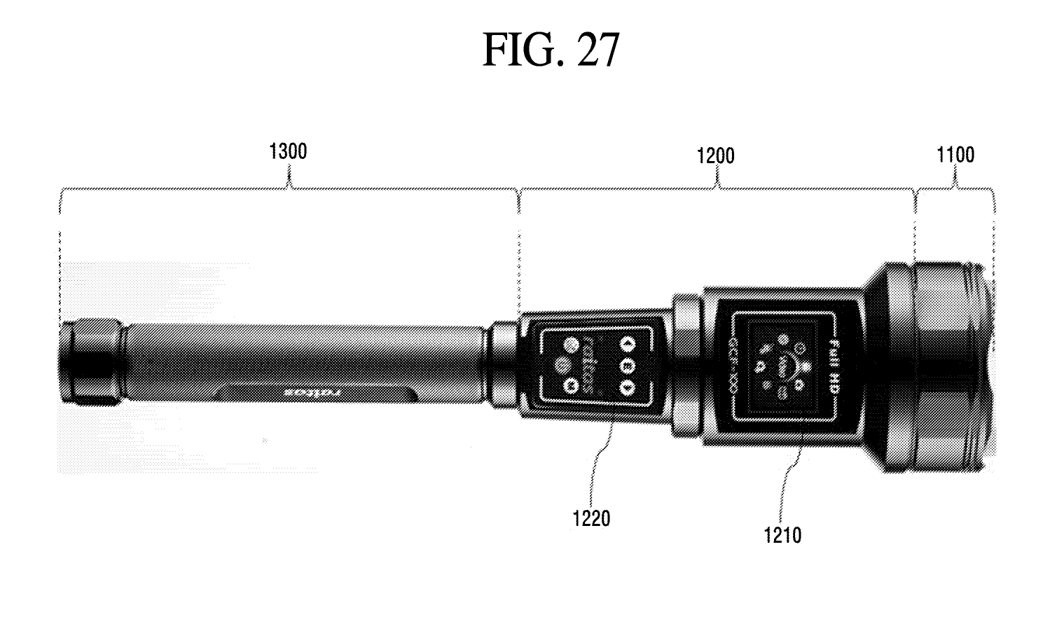

The structure of the AV flashlight according to the second embodiment will now be explained with reference to FIGS. 27 to 34.

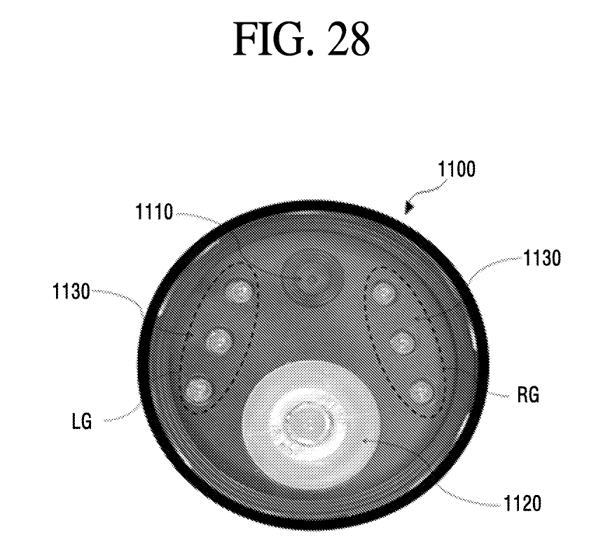

First, referring to FIGS. 27 and 28, the AV flashlight according to the second embodiment may mainly include a head portion 1100, a body portion 1200 and a rear portion 1300. The head portion 1100 may include a video camera module 1110, a visible light source module 1120, and an infrared light source module 1130 which are arranged on a front surface. The optical axes of the video camera module 1110 and the visible light source module 1120 are arranged vertically on a vertical bisector of the front surface of the head portion 1100, and three infrared light emitting diodes of the infrared light source module 1130 are arranged on left side and another three infrared light emitting diodes are arranged on right side thereof. The left-side group (LG) of the infrared light emitting diodes are arranged to be inclined so that the diodes are at gradually increasing distance from a left to a lower direction, while the right-side group (LG) is arranged to be inclined so that the diodes are at gradually increasing distance from a right to a lower direction. The image display module 1210 and the keypad module 1220 are respectively mounted on the outer circumference of the body portion 1200.

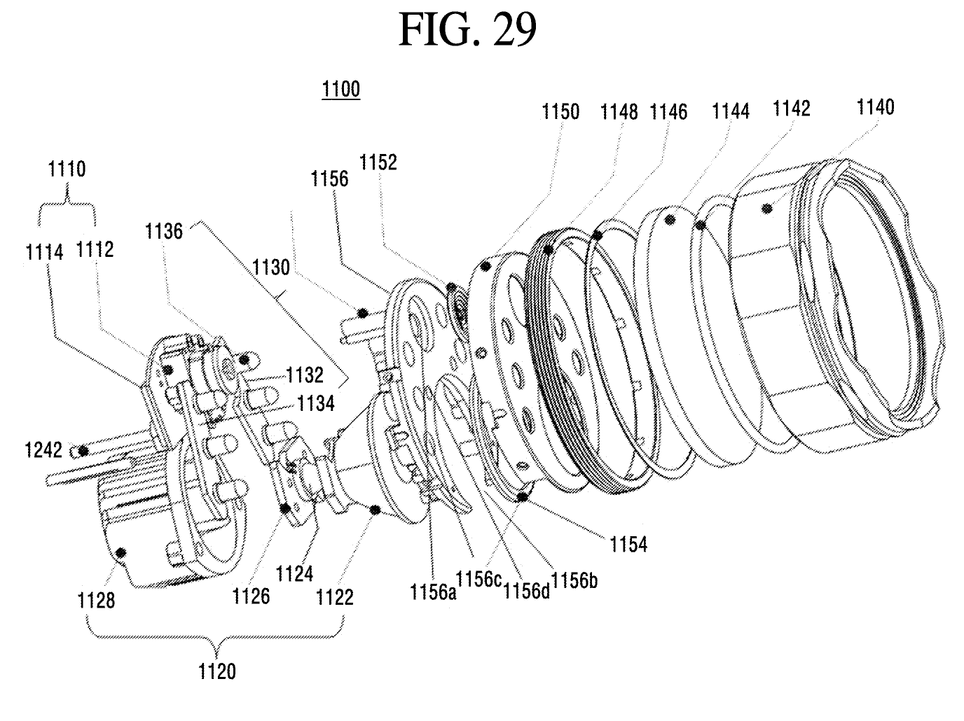

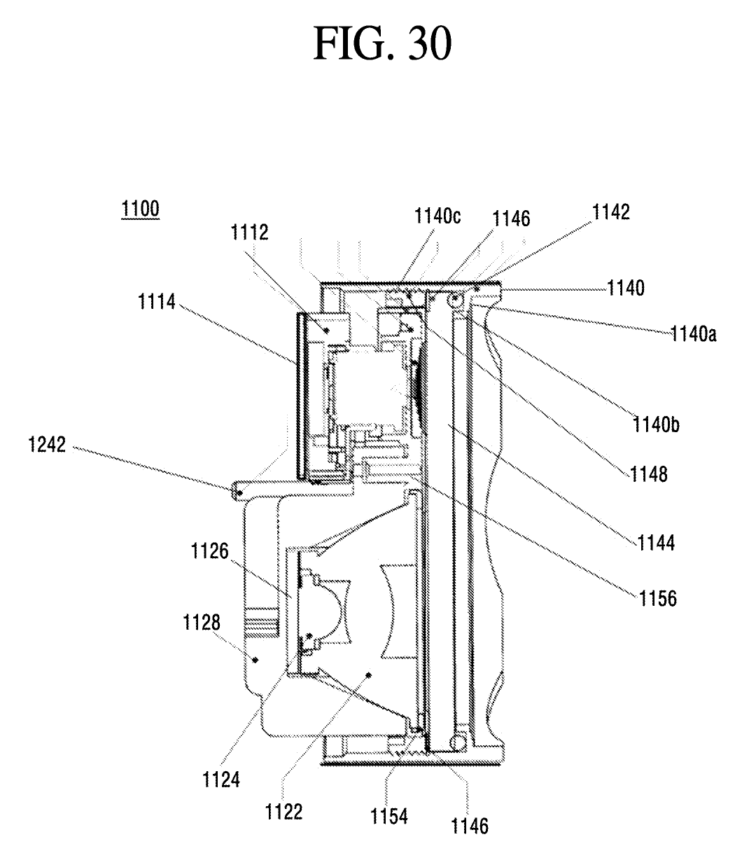

Referring to FIGS. 29 and 30, the head portion 1100 may include, in an order from the right side, a head lens barrel 1140, an O ring 1142, a transparent lens 1144, an annular frame 1146, a fixing annular frame 1148, a housing cover 1150, a light receiving lens 1152, a fixing annular frame 1154, a head housing 1156, an aspheric collimating lens 1122, a white LED 1124, a board 1126, a heat dissipating cover 1128, a right board 1132, a left board 1134, a video camera 1112, and a camera board 1114.

The head lens barrel 1140 may include a locking protrusion 1140a formed on a leading end of an inner circumference by aluminum machining. The locking protrusion 1140a may have a smaller inner diameter than the outer diameter of the transparent lens 1144. An annular groove 1140b is formed on a rear surface of the locking protrusion 1140a to receive the O ring 1142 therein. On an inner circumference of the head lens barrel 1140, a female thread 1140c is extended from a rear surface of the locking protrusion 1140a to a rear end.

Accordingly, in assembling, the O ring 1142 is inserted in the annular groove 1140b, the transparent lens 1144 and the annular frame 1146 are placed in sequence on the O ring 1142, and the fixing annular frame 1148 is screw-coupled to press-fit the transparent lens 1144 to the head lens barrel locking protrusion 1140a. Due to presence of the O ring 1142, the head is waterproof at 10 m or deeper depth of water. For example, the head may be 30 m water pressure resistant.

A male thread is formed on an outer circumference of the fixing annular frame 1148, and may preferably have a larger inner diameter than that of the locking protrusion 1142a. The annular frame 1146 is interposed between the transparent lens 1144 and the fixing annular frame 1148 to protect the surface of the transparent lens 1144. The transparent lens 1144 may be made from high strength transparent glass (e.g., Pylex glass) that has 97% light transmission and 30 m water pressure resistance.

The head housing 1156 is formed by aluminum die-casting, and may take a form of a circular plate which has an outer diameter larger than the inner diameter of the locking protrusion 1142a and smaller than the inner diameter of the fixing annular frame 1148. The front surface may be generally planar, but the rear surface may include recesses or protrusions to support components or enable screw-coupling.

The head housing 1156 may include a plurality of mounting holes 1156a, 1156b, 1156c, 1156d formed therein. In the proximity to the leading end of the mounting hole 1156a, an insertion hole to receive the light receiving lens 1152 is formed. The light receiving lens 1152 may have a dish-like lens structure having a diameter greater than the inner diameter of the mounting hole 1156a to widen the angle of view of the camera photographing. The video camera module 1110 may be mounted on a rear surface of the head housing 1156 so that the central axis of the mounting hole 1156a of the head housing 1156 is aligned with the optical axis, and screw-coupled in position.

The video camera module 1110 may include a video camera 1112 and a board 1114. The video camera 1112 may implement fixed focus method and include a lens module, and a CMOS image sensor of FULL HD specification. The lens module of the video camera 1112 includes an infrared shift cut shutter arranged on a light receiving path of the CMOS image sensor. The infrared shift cut shutter passes only the infrared ray in the infrared light mode, i.e., in the infrared mode (night vision mode), but moves out of the light path to pass the visible light in the visible light mode. The CMOS image sensor may be, for example, 1/2.5 inch Full HD image sensor (ST9P001) of Micron.

The mounting hole 1156b has the largest diameter than any other mounting holes and has a predetermined open portion. The fixing annular frame 1154 is screw-coupled to the leading end of the mounting hole 1156b, and the aspheric collimating lens 1122 is fixedly inserted in the rear end of the mounting hole 1156b. The white LED 1124 is engaged with the rear end of the aspheric collimating lens 1122, and the white LED 1124 is mounted on the board 1126 which has high degree of heat conductivity. The white LED 1124 may implement 150 to 450 Lm white LED of Cree. The board 1126, the white LED 1124, and the aspheric collimating lens 1122 are press-fit with each other by the heat dissipating cover 1128, and then screw-coupled to the rear surface of the head housing 1156. Accordingly, since the high brightness white LED 1124 and the board 1126 are coupled with each other in a manner of conducting heat by the surface contact with the heat dissipating cover 1128, the heat is dissipated outside through the heat dissipating cover 1128 instantly as the heat is generated from the white LED 1124.

The heat dissipating cover 1128 is an aluminum casing with good heat conductivity, and may include a heat dissipating pin structure on the outer surface thereof to increase the surface area and thus enable rapid heat dissipation. One side surface of the heat dissipating cover 1128 may be formed into an arc-shaped surface, which is surface-contacted with the inner circumference of the fixing annular frame 1148 and the inner circumference of the lens barrel portion 1230 to conduct heat for dissipation.

Total six mounting holes 1156c may be formed on left and right sides of the mounting hole 1156c (i.e., three on left side and three on right side), and six infrared light emitting diodes 1136 are inserted into the respective mounting holes 1156c. The infrared light source module 1130 may include a right board 1132, a left board 1134 and infrared light emitting diodes 1136. Three infrared light emitting diodes 1136 may be arranged in a line on the right board 1132, and another three infrared light emitting diodes 1136 may be arranged in a line on the left board 1134. The left and right boards 1132, 1134 may be firmly fixed to the rear surface of the head housing 1156 by screw-coupling.

Two mounting hole 1156d may be arranged along a central horizontal line, and formed on left and right sides at distance from the vertical bisector. A coupling means of the body portion 1200 is coupled by being inserted into the mounting hole 1156d.

The housing cover 1150 is placed on the front surface of the head housing 1156 and fixed to the head housing 1156 by the screw. A plurality of through holes corresponding to the mounting holes of the head housing 1156 may be formed in the housing cover 1150. The front surface of the housing cover 1150 is anti-reflection coated with black body. Accordingly, the light emitted from the white visible light source module does not affect the video camera module 1110. The outer diameter of the housing cover 1150 is smaller than the inner diameter of the fixing annular frame 1148.

As the head housing assembly is constructed in the manner explained above, a cable is connected, and the head housing assembly is connected to the body portion 1200, so that the head housing assembly is maintained in a state of being integrally assembled with the circuit parts of the body portion 1200. By connecting the head lens barrel 1140 to the body portion 1200, the head housing assembly is arranged inside the head lens barrel 1140. Such connected structure of the head housing enables convenient assembly and disassembly due to easier cable maintenance during disassembling, minimized cable length, and reduced assembly error of the cable connecting portion.

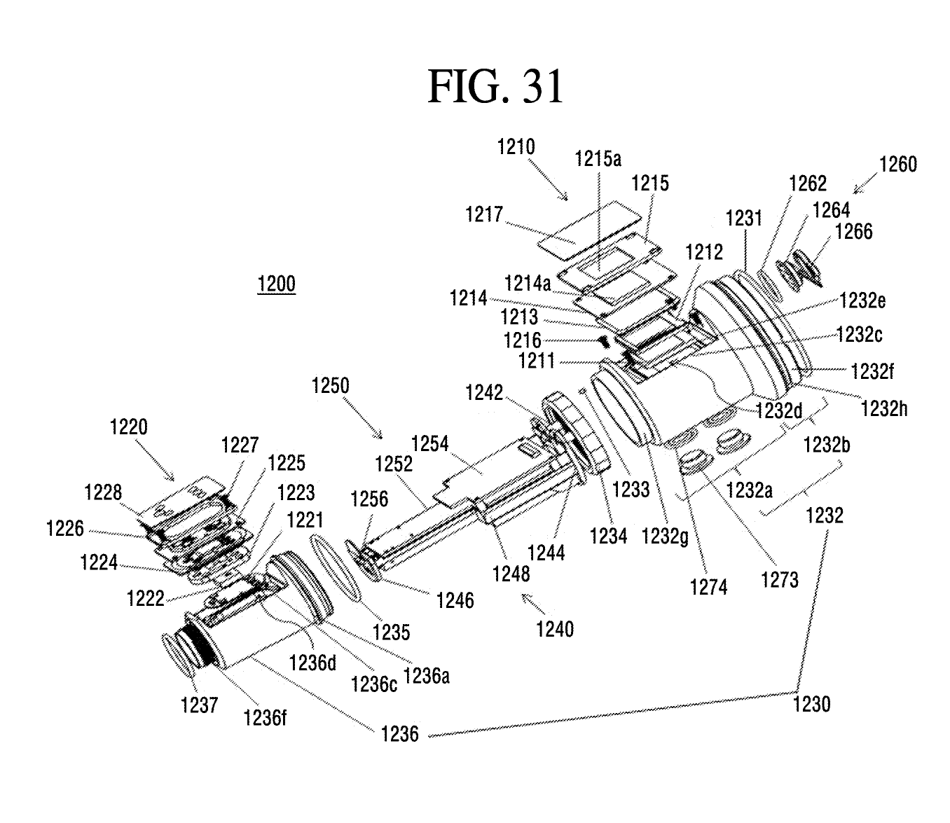

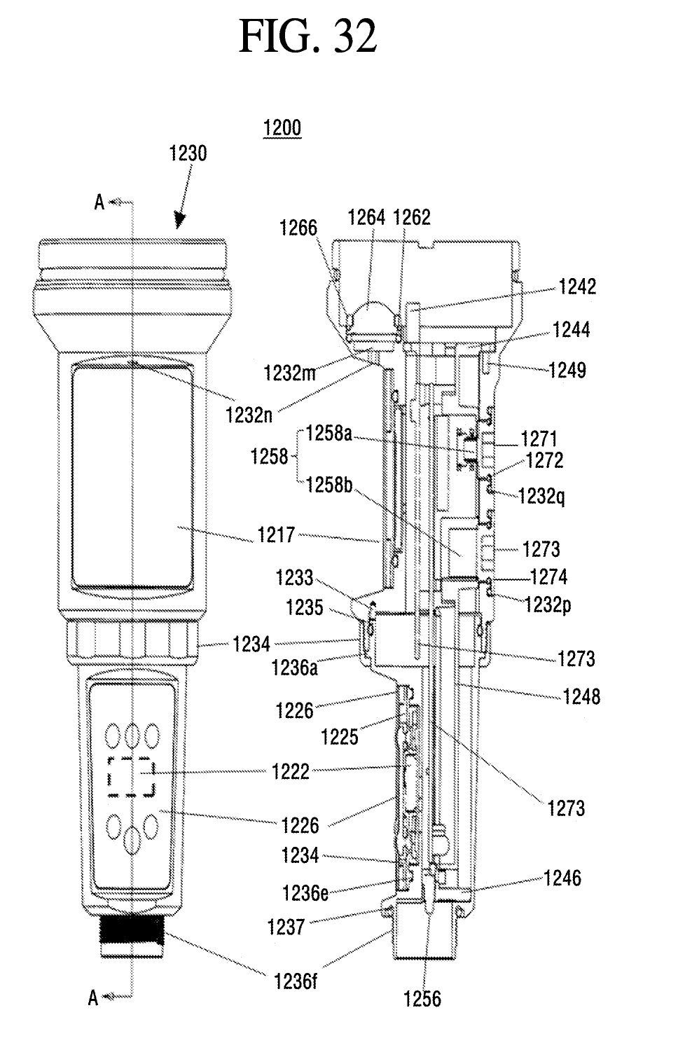

Referring to FIGS. 31 and 32, the body portion 1200 may include an image display module 1210, a keypad module 1220, a lens barrel portion 1230, a board housing 1240, a circuit board 1250 and a microphone module 1260.

The image display module 1210 may include a liquid crystal panel 1211, an edge cover 1212, a square ring 1213, a transparent plate 1214, a metal plate 1215, a screw 1216 and an external film 1217.

The keypad module 1220 may include a keypad board 1221, a GPS chip 1222, an interval maintaining plate 1223, a rubber cover 1224, a pressing plate 1225, a metal plate 1226, a screw 1227 and an external film 1228.

The lens barrel portion 1230 may include an O ring 1231, a first lens barrel 1232, an aligning means 1233, a fixing nut 1234, an O ring 1235, a second lens barrel 1236, and an O ring 1237.

The first lens barrel 1232 includes an accommodating portion 1232a having a first diameter, and a leading end connecting portion 1232b having a second diameter which is greater than the first diameter and smaller than the inner diameter of the head lens barrel 1140. A first mounting hole 1232c is formed in the outer circumference of the accommodating portion 1232a, and an opening 1232d in fluid communication with the interior of the accommodating portion 1232a is formed in a bottom of the first mounting hole 1232c. On the bottom around the opening 1232d, an inserting hole 1232e is formed.

The image display 1210 is mounted on the first mounting hole 1232c in the following manner. That is, the liquid crystal panel 1211 and the edge cover 1212 are positioned in order on the opening 1232d, the square ring 1213 is inserted in the inserting hole 1232e, and the transparent plate 1214 and the metal plate 1215 are press-fit, and the screw 1216 is fastened. Finally, the external film 1217 is attached so that the screw 1216 is hidden. The square ring 1213 and the edge cover 1212, both made from elastic rubber material, may be provided for waterproof of the connecting portion of the first mounting hole 1232c. The transparent plate 1214 may have the same size as the metal plate 1215, and include a protrusion 1214a formed at the center to be inserted in the opening 1215a of the metal plate 1215.

Screw threads 1232f, 1232g are formed on outer circumferences of the leading and rear ends of the first lens barrel 1232. The leading end screw thread 1232f is screw-engaged with the female thread 1140c on the inner circumference of the head lens barrel 1140. An inserting hole 1232h is formed on the outer circumference of the rear portion of the leading end screw thread 1232f, and the O ring 1231 is inserted therein. The O ring 1231 is provided for waterproof of the connecting portion between the head lens barrel 1140 and the first lens barrel 1232.

A microphone mounting hole 1232m is formed on an upper portion of the inner sidewall of the connecting portion 1232b of the first lens barrel 1232. a plurality of through holes 1232n is extended from an upper sidewall of the first mounting hole 1232c to the microphone mounting hole 1232m of the connecting portion 1232b. The microphone module 1260 may include an O ring 1262, a microphone 1264 and a fixing metal plate 1266. The microphone module 1260 is fixed in place in the following manner. That is, the O ring 1262 and the microphone 1264, facing a direction of the through holes 1232n, are inserted into the microphone mounting hole 10232m, and the fixing metal plate 1266 is press-fit and fastened with the screw. Accordingly, the O ring 1262 is provided for waterproof of the connecting portion of the microphone mounting hole 1232m.

Two through holes 1232p, 1232 are formed on an outer circumference opposite to the first mounting hole 1232c of the first lens barrel 1232. The through holes 1232p, 1232q each has a screw thread on an inner circumference thereof, and screw-engaged with screw caps 1271, 1273 to block the through holes 1232p, 1232q from outside. O rings 1272, 1274 are mounted around the respective through holes 1232p, 1232q to provide waterproof of the connecting portion. Either linear groove or hexagonal hole may be formed on an external surface of the screw caps 1271, 1273 to enable fastening or unfastening of the screw by coin or hexagonal wrench. A screw hole may also be formed on the external surface of one of the screw caps 1271, 1273 to enable fixing on a camera tripod.

The second lens barrel 1236 may be tapered in which the outer diameter gradually decreases in a direction from leading to rear ends.

The second lens barrel 1236 may include a locking protrusion 1236a formed on an outer circumference of the leading end, and an inner rear end of the fixing nut 1234 is locked with the locking protrusion 1236a. An outer diameter of the leading end of the second lens barrel 1236 is smaller than the inner diameter of the rear end, and accordingly, the leading end of the second lens barrel 1236 is inserted in the first lens barrel, and the rear end of the first lens barrel 1232 is locked with the locking protrusion 1236a. Accordingly, by the screw-coupling of the fixing nut 1234 with the screw thread 1232g of the first lens barrel, the second lens barrel 1236 is engaged with the rear end of the first lens barrel 1232. An O ring 1235 is interposed on the connecting portion between the first and second lens barrels 1232, 1236.

Aligning holes (not illustrated) with centers aligned with each other may be formed on the facing and contacting surfaces of the first and second lens barrels 1232, 1236. The aligning pins 1233 are inserted into the aligning holes to thus align the horizontal position of the first and second lens barrels 1232, 1236. That is, in a state that the aligning pin 1233 is fixed in the aligning hole of the first lens barrel 1232, the aligning pin 1233 is inserted into the aligning hole of the second lens barrel 1236 so that the first mounting hole 1232c of the first lens barrel 1232 and the mounting hole 1236c of the second lens barrel 1236 are arranged in a line.

A second mounting hole 1236c is formed on an outer circumference of the second lens barrel 1236, and the keypad module 1220 is mounted inside the second mounting hole 1236c. An opening 1236d in fluid communication with the interior of the second lens barrel 1236 is formed on the bottom of the second mounting hole 1236c. An inserting hole 1236e is formed on the bottom around the opening 1236d.

The keypad module 1220 is mounted in the following manner. That is, in the second mounting hole 1236c, the keypad board 1221, the GPS chip 1222, the interval maintaining plate 1223, the rubber cover 1224, the pressing plate 1225 and the metal plate 1226 are mounted in order, fastened and fixe din place by the screw 1227, and then the external film 1228 is attached thereto.

The keypad board 1221, arranged on the opening 1236d of the second mounting hole 1236c, is connected to the circuit board 1250 via the flexible cable. Herein, the circuit board 1250 is exposed through the opening 1236d of the second mounting hole 1236c. The GPS chip (module) 1222 is mounted at the center of the keypad board 1221, and a plurality of keypads is arranged therearound. The pressing plate 1225 may take the form of a square rubber plate, and include a protruding annular frame formed on a lower surface to be inserted into a sealing groove formed around the opening 1236d of the second mounting hole 1236c, and a plurality of pressing protrusions formed in correspondence to the keypads of the keypad board 1221. The metal plate 1226 includes an opening formed at the center, and uniformly press-fits the edge of the pressing plate 1225 (i.e., square rubber plate). The metal plate 1226 is fixed to the bottom of the second mounting hole 1236c by screw-coupling. Key shapes are printed on the external film at locations corresponding to the plurality of pressing protrusions. The external film 1228 is attached to the metal plate 1226.

A screw thread 1236f is formed on an outer circumference of a rear end of the second lens barrel. The leading end of the rear portion 1300 is screw-engaged with the screw thread 1236f. The O ring is interposed on the connecting portion between the second lens barrel 1236 and the rear portion 1300.

In one embodiment, the lens barrel portion 1230 may be divided into the first and second lens barrels 1232, 1236. However, other examples are also possible. For example, the first and second lens barrels 1232, 1236 may be integrally formed with each other. In the integrated lens barrel, the first and second mounting holes are arranged in a line along a direction of the central line on the outer circumference.

The board housing 1240 is a box-type housing with an open upper portion, which includes a front 1244, a rear plate 1246, and a supporting plate 1248 to connect the front and rear plates 1244, 1246. The board housing 1240 may be formed by plastic injection molding. Accordingly, the board housing 1240 is slid into and accommodated in the interior of the lens barrel portion 1230.

The front plate 1244 is surface-contacted with the inner sidewall of the connecting portion 1232b of the first lens barrel 1232 and fixed in place by the screw 1249. An engaging means, which is engaged with the head portion 1100, is formed on the front surface of the front plate 1244. That is, two supporting bars 1242 are formed on the front surface of the front plate 1244 at predetermined distance from each other and extend to the front direction. One end of the supporting bar 1242 is firmly fit with a bushing protruding in a forward direction from the front plate 1244. The other end of the supporting bar 1242 is firmly inserted in the through hole 1156d of the head housing 1156. Likewise, the through hole 1156d of the head housing 1156 refers to the through hole that passes through the bushing protruding in a rear direction. The idea of the supporting bar 1242 is to firmly fix the head portion 1100 on the body portion 1200 with a metal bar. A cable hole, jack or connector may be installed or mounted on the front plate 1244. That is, connecting means to supply electrical signal and power to the respective components may be provided.

The rear plate 1246, which may take a semi-circular configuration, is extended through the interior space and arranged on a rear end of the second lens barrel 1236. A terminal unit 1256 to be electrically contacted with the battery module protrudes from the rear plate 1246 to a rear direction, thus forming an elastic contact point.

The circuit board 1250 is fixed on top of the supporting plate 1248. The width of the portion of the supporting plate 1248, which is arranged in the interior space of the first lens barrel 1232, is wider than the width of the portion arranged in the interior space of the second lens barrel 1236.

The circuit board 1250 includes a lower board 1252, i.e., a power control board, and an upper board 1254, i.e., a main control board.

The lower board 1252 has the same length as the full length of the board housing 1240 and fixed on the supporting plate 1248 of the board housing 1240. The upper board 1254 is arranged on the lower board 1252, with four corners fixed by the screws on four upwardly protruding support columns of the supporting plate 1248.

A welding portion to be electrically connected to the terminal unit 1256 is provided on a rear end of the lower board 1252, and a connector to connect to the keypad module 1220 is provided on top of a location that corresponds to the opening 1236d of the second mounting hole 1236c. An external connect terminal unit 1258, such as, for example, HDMI jack 1258a or a flash memory socket 12528b, may be formed at locations that face two through holes 1232p, 1232q are provided on a lower surface of the lower board 1252. Herein, USB jack or similar external signal connect jack may be used instead of the HDMI jack 1252a.

The external connect terminal unit 1258 may be formed such that the HDMI jack 1258a and the flash memory socket 1258b may be formed at a proximity to each other at a location that corresponds to one through hole.

The lower board 1252 is connected to a cable to supply electricity to the visible light source module 1120 and the infrared light source module 1130 of the head portion 1100. The lower board 1252, the keypad module 1220 and the GPS module are connected to each other via flexible cable.

The upper board 1254 is electrically connected to the lower board 1252, and mounts thereon a micro processor chip or a memory chip to control the system. The upper board 1254 is connected to a cable to supply a control signal to the image display module 1210, the video camera module 1110 and the audio module 1260 and receive an input signal. The keypad module 1220 is connected to the upper board 1254 via the lower board 1252. The upper board 1254, the image display module 1210 and the video camera module 1110 are connected to each other via flexible cables.

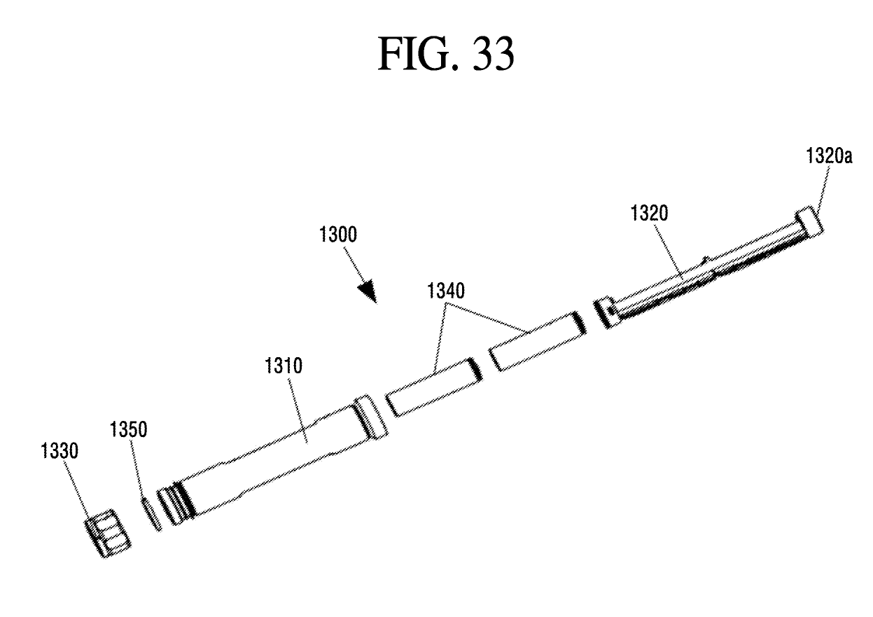

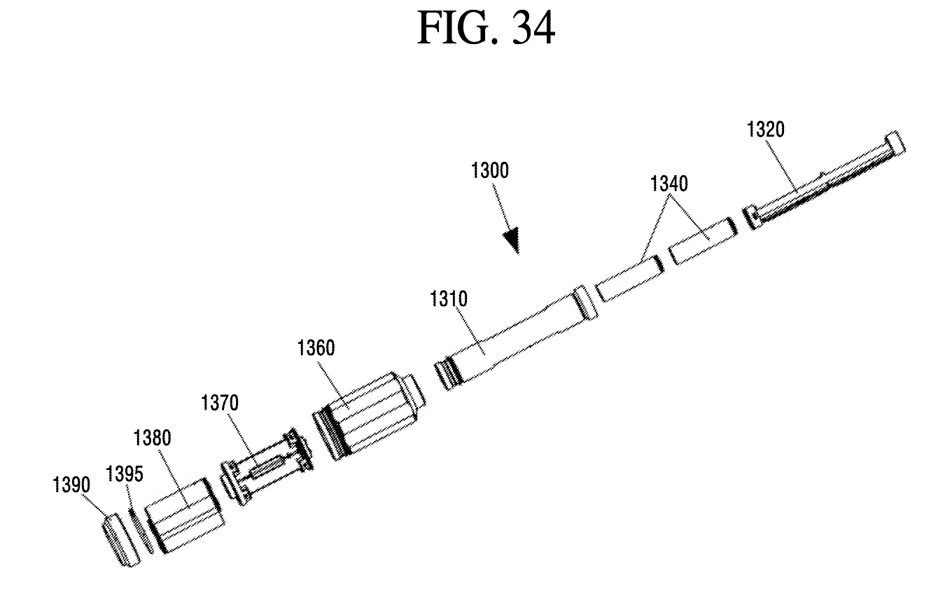

Referring to FIGS. 33 and 34, the rear portion 1300 includes a rear lens barrel 1310, a battery housing 1320, a rear cap 1330, a battery 1340, and an O ring 1350. Two rechargeable batteries 1340 may be removably mounted within the battery housing 1320, and a central copper disc to be connected to the terminal unit 1256 and a copper hook plate arranged around the central copper disc are formed on the leading end surface 1320a of the battery housing 1320. The O ring 1350 is interposed between the rear end and the rear cap 1330 of the rear lens barrel 1310 to seal the rear lens barrel 1310. The battery 1340 may be implemented as a 18650 lithium ion battery which is usable up to 4.5 hours maximum for lighting purpose only, or up to 3.5 hours maximum for both video recording and lighting purposes.

The rear portion 1300 may additionally include a secondary battery lens barrel 1360, a secondary battery housing 1370, four secondary batteries 1380, a secondary rear cap 1390, and an O ring 1395. After the rear cap 1330 of the secondary battery lens barrel 1360 is removed, the leading end of the secondary battery lens barrel 1360 may be screw-coupled with the rear end of the rear lens barrel 1310. Four secondary batteries 1380 housed in the secondary battery housing 1370 may be received in the secondary battery lens barrel 1360. The secondary battery 1380 has the same size and capacity as the battery 1340, and arranged in parallel in the battery housing 1370. The diameter of the secondary battery lens barrel 1360 is greater than that of the rear lens barrel 1310. The secondary battery 1380 may be used when video recording extends for a long period of time. The O ring 1395 is interposed between the rear end of the secondary battery lens barrel 1360 and the secondary rear cap 1390.

The AC flashlight constructed as explained according to the second embodiment may be used in the following manner.

The keypad module 1220 may include various keys to manipulate the AV flashlight. By way of example, a key to turn on/off visible light source and infrared light source, a key to turn on a video camera to display video on the image display module 1210 and record predetermined video, or a key to record sound using the microphone module 1260. Accordingly, the user is able to use the original function of the AV flashlight 1100 according to the embodiment by turning on or off the visible light source module 1120 using the keypad module 1220.

Further, the user may take a video as he wishes by manipulating the video camera module 1110 using the keypad module 1220 and the image display module 1210. At night, the user may turn on the infrared light source module 1130 with the keypad module 1220, operate the video camera module 110 and take a video shot. Further, if necessary, the user may record sound by manipulating the microphone module 1260 with the keypad module 1220.

Since the AV flashlight according to the second embodiment is at least 10 m waterproof, the user can take images and record sound by manipulating the keypad module 1220 even in rains, or under river or sea.

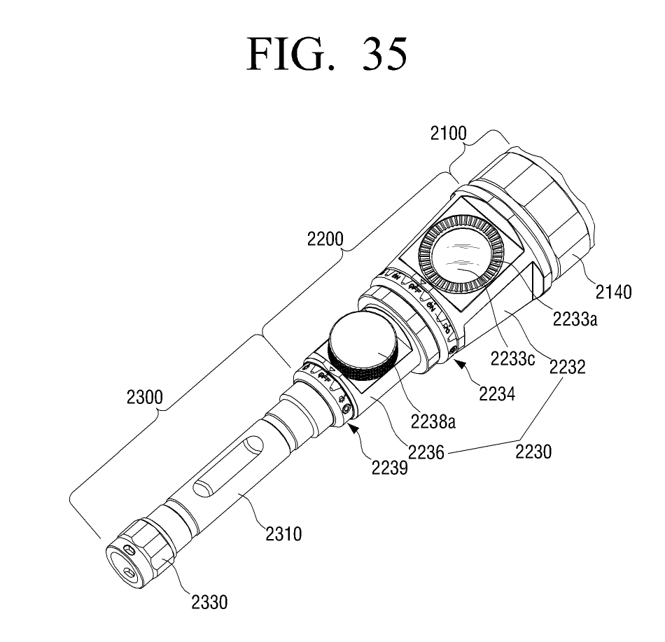

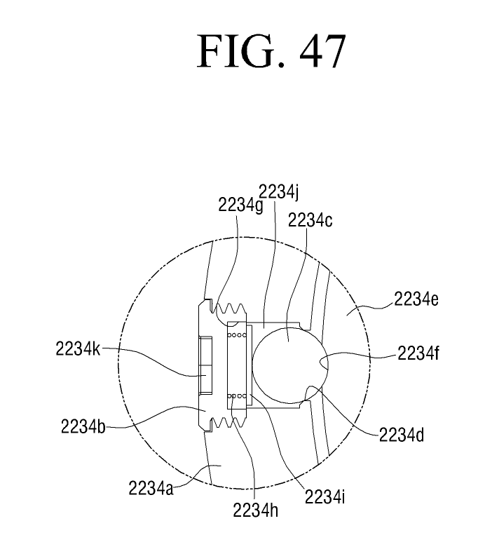

The structure of an AV flashlight according to a third embodiment will now be explained with reference to FIGS. 35 to 49.

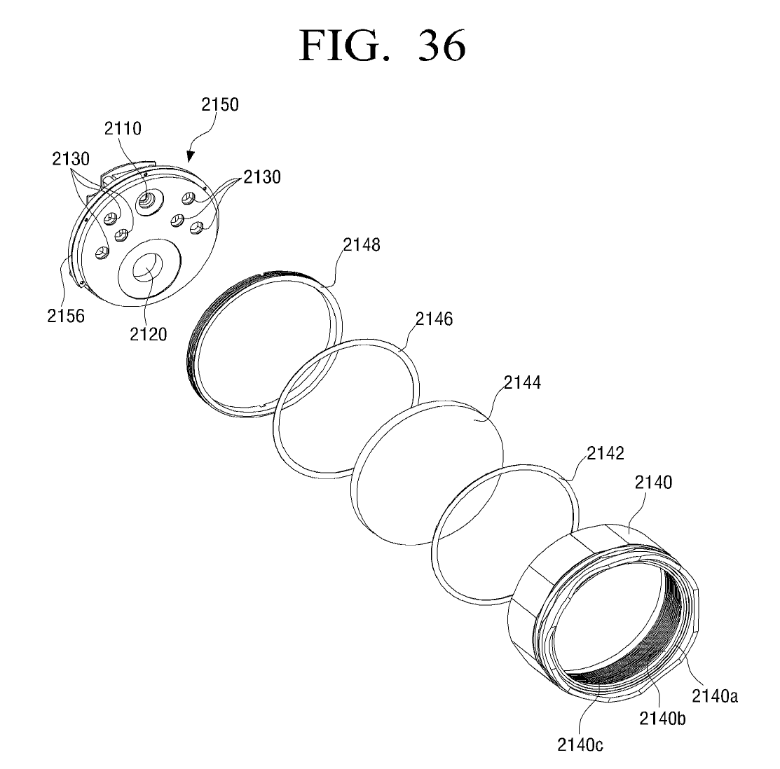

Referring to FIGS. 35 and 36, the AV flashlight according to an embodiment may mainly include a head portion 2100, a body portion 2200 and a rear portion 2300.

The head portion 2100 may include, in order from the left side, a head lens barrel 2140, an O ring 2142, a transparent lens head lens barrel, an annular frame 2146, a fixing annular frame 2148, and a head housing assembly 2150.

The head lens barrel 2140 has a locking protrusion 2140a formed on a leading end of an inner circumference by aluminum machining. The locking protrusion 2140a has an inner diameter smaller than the outer diameter of the transparent lens head lens barrel. An annular groove 2140b is formed on a rear surface of the locking protrusion 2140a to receive the O ring 2142 therein. A female thread 2140c extends on an inner circumference of the head lens barrel 2140 from the rear surface of the locking protrusion 2140a to the rear end.

Accordingly, in assembling, the O ring 2142 is inserted in the annular groove 2140b, the transparent lens 2144 and the annular frame 2146 are placed in sequence on the O ring 2142, and the fixing annular frame 2148 is screw-coupled to press-fit the transparent lens 2144 to the head lens barrel locking protrusion 2140a. Due to presence of the O ring 2142, the head is treated to be completely waterproof.

A male thread is formed on an outer circumference of the fixing annular frame 2148, and may preferably have a larger inner diameter than that of the locking protrusion 2140a. The annular frame 2146 is interposed between the transparent lens 2144 and the fixing annular frame 2148 to protect the surface of the transparent lens 2144. The transparent lens 2144 may be made from high strength transparent glass (e.g., Pylex glass) that has 97% light transmission and 30 m water pressure resistance. By setting the thickness to approximately 5.5 mm, the degree of water resistance may be increased to between 20 m and 100 m.

The head housing assembly 2150 may include a video camera 2110, a visible light source 2120, and an infrared light source 2130 arranged therein. The optical axes of the video camera module 2110 and the visible light source module 2120 are arranged vertically on a vertical bisector of the front surface of the head portion 2100, and three infrared light emitting diodes of the infrared light source module 2130 are arranged on left side and another three infrared light emitting diodes are arranged on right side. In one example, to identify objects at night, the infrared light emitting diodes on left and right sides may preferably arranged in the proximity to the video camera 2110, and as near as possible to the video camera 2110.

The video camera 2110 may include a board (not illustrated) and a single module, and have the same structure as the video camera 1110 of the second embodiment.

The visible light source 2120 may be a white LED such as 150 to 450 Lm white LED of Cree. Since the high brightness white LED and the board on which the high brightness white LED is mounted are coupled with each other in a manner of conducting heat by the surface contact with the heat dissipating cover (not illustrated), the heat is dissipated outside through the heat dissipating cover instantly as the heat is generated from the white LED.

The head housing 2156 is formed by aluminum die-casting, and may take a form of a circular plate which has an outer diameter larger than the inner diameter of the locking protrusion 2140a and smaller than the inner diameter of the fixing annular frame 2148. The front surface may be generally planar, but the rear surface may include recesses or protrusions to support components or enable screw-coupling. Further, considering that the visible light source (i.e., white LED) of the head housing 2156 generates considerable heat, a dissipating cover (not illustrated) may be arranged in back of the head housing 2156 in contact with the bard (not illustrated) on which the visible light source 2120 is mounted to maximize the cooling efficiency of the visible light source 2120. The heat dissipating cover may be an aluminum casing with good heat conductivity, and may include a heat dissipating pin structure on the outer surface thereof to increase the surface area and thus enable rapid heat dissipation. Further, the heat dissipating cover may preferably be surface-contacted with the inner circumference of the fixing annular frame 2148 and inner circumference of the lens barrel 2230 of the body portion 220 to conduct heat for dissipation.

The head housing assembly 2150 constructed in a manner explained above does not need individual connecting of the circuit parts of the body portion 220 through the cable. That is, by simply assembling the head housing assembly 2150 on a leading end of the board housing 2240, mutual electrical connection is completed. To do so, general female/male socket connection may be used to connect the head housing assembly 2150 to the board housing 2240. Since difficulty of assembling between the head housing assembly 2150 and the board housing 2240 is lessened as explained above, assembling and disassembling become easier, and work efficiency and productivity increase.

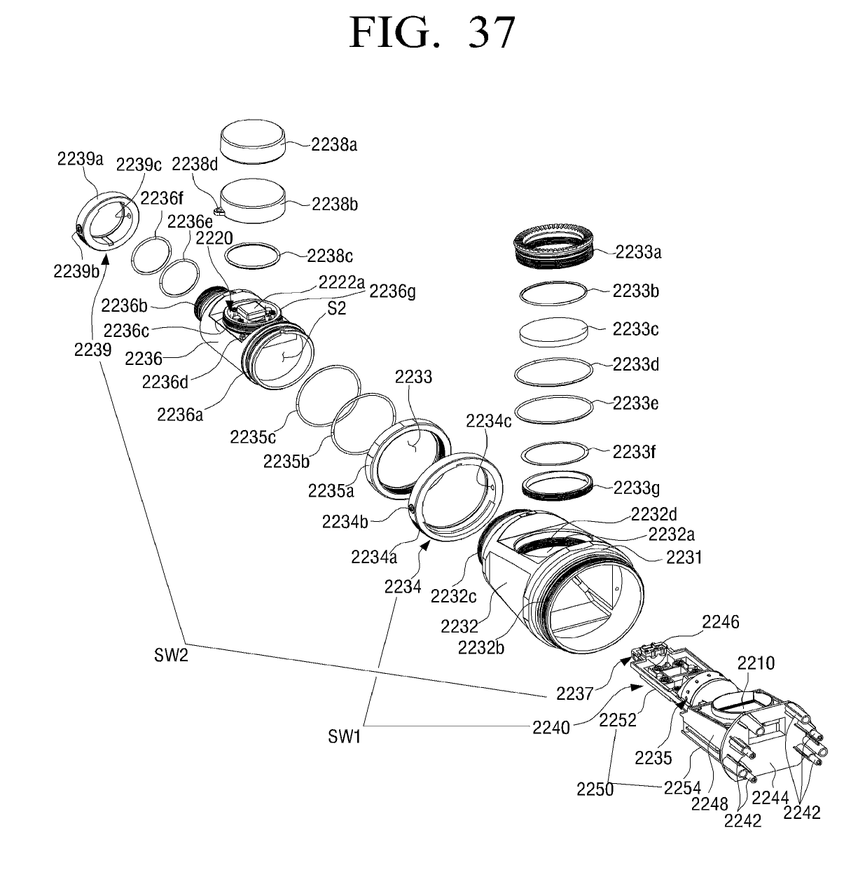

Referring to FIG. 37, the body portion 2200 may include an image display module 2210, a keypad module 2220, a lens barrel portion 2230, a board housing 2240, a circuit board 2250, and a microphone module 2260.

The image display module 2210 is formed on one side of the board housing 2240 to face a window unit 2233. In such an example, the user may check the content currently displayed on LCD (e.g., image being recorded, previously-recorded image, or photograph menu) through the window unit 2233 mounted on a first mounting hole 2232d of the first lens barrel 2232.

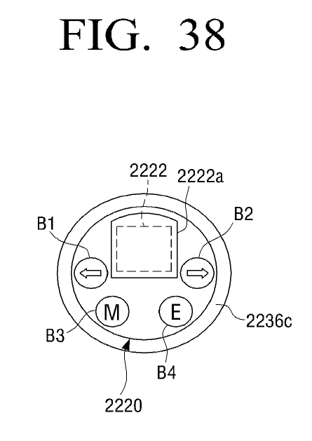

Referring to FIG. 38, the keypad module 2220 is formed on one side of the second lens barrel 2236, and includes a left move key B1, a right move key B2, a menu display key B3 and an enter key B4 to select the photograph menu displayed on the LCD.

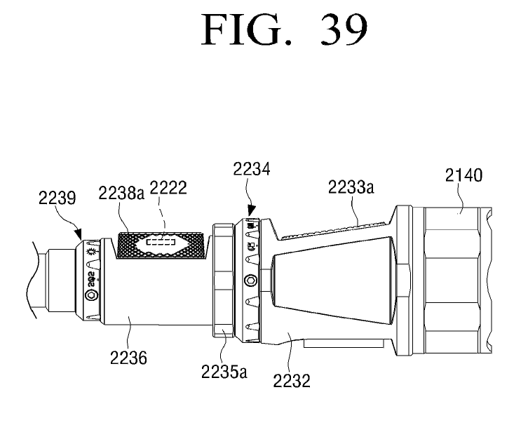

In one embodiment, the keypad module 2220 may include a GPS receiving module 2222 which is molded by a mold 2222a. Referring to FIG. 39, the GPS receiving module 2222 may be arranged on a protruding location which is at a predetermined height from the second lens barrel 2236, instead of being sunken in the second lens barrel 2236, so as to increase the GPS signal receptivity. By the above-explained arrangement, GPS signal from the satellite is received at the GPS receiving module 2222 at any angle and without suffering interferences.

Referring to FIG. 37, the keypad module 2220 and the GPS receiving module 2222 are surrounded by a fastening annular frame 2236g which is airtightly screw-coupled with a second mounting hole 2236c of the second lens barrel. The fastening annular frame 2236g may optionally be coupled with a metal cap 2238a or a plastic cap 2238b (Note that the plastic cap may be made from synthetic resin or it is possible to implement smooth synthetic rubber material for better feel). The metal cap 2238a is screw-coupled with the fastening annular frame 2236a and airtightness between the metal cap 2238a and the fastening annular frame 2236a is maintained by the O ring 2238c. The metal cap 2238a may prevent unintentional pressing of the key of the keypad module 2220 due to water pressure and subsequent malfunctioning when the AV flashlight is used under water. The plastic cap 2238b may be used to protect the keypad module 2220 and the GPS receiving module 2222 instead of the metal cap 2238a particularly when the AV flashlight is used outside the water. The plastic cap 2238b may be integrally formed with a connecting hook 2238d on one side and thus can be tied to a locking protrusion 2236d of the second lens barrel 2236 by a predetermined chain or strap.

The lens barrel portion 2230 includes an O ring 2231, a first lens barrel 2232, a window unit 2233, a fastening nut 2235a, O rings 2235b, 2235c, a second lens barrel 2236, O rings 2236e, 2236f, and a first rotary switch and a second rotary switch SW1, SW2.

The first lens barrel 2232 includes a first mounting hole 2232d having a first diameter, and a leading end connecting portion 2232b having a second diameter which is greater than the first diameter and smaller than the inner diameter of the head lens barrel 2140.

Screw threads are formed on outer circumferences of the leading end connecting portion 2232b and the rear end connecting portion 2232c of the first lens barrel 2232. The screw thread of the leading end connecting portion 2232b is screw-coupled with the female thread 2140c (see FIG. 36) on the inner circumference of the head lens barrel 2140. The O ring 2231 is inserted in the outer circumference of the rear portion of the screw thread 2232b of the leading end connecting portion 2232b. The O ring 2231 is provided for waterproof of the connecting portion between the head lens barrel 2140 and the first lens barrel 2232.

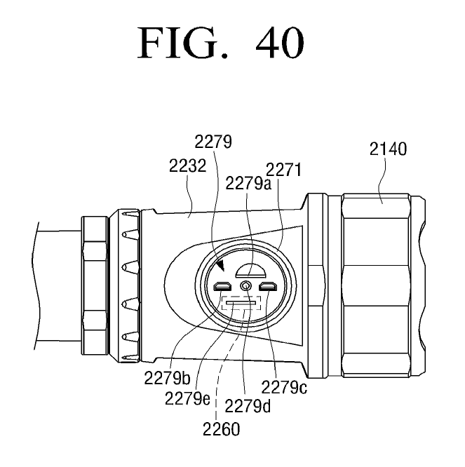

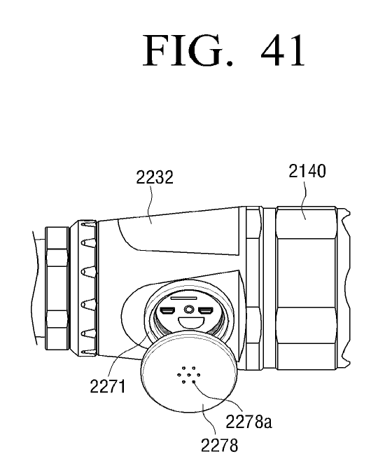

Referring to FIG. 40, a compact-sized microphone module 2260 is mounted on an inner side of the first lens barrel 2232. Outside the water, it is possible to record sound using the microphone module 2260 through a microphone hole 2279e of the external connect terminal unit 2279. It is preferable that a plastic cap 2278 with a plurality of small through holes 2278a formed therein is removably connected to the fastening annular frame 2271 installed on the other side surface of the first lens barrel 2232 (see FIG. 41) to protect the external connect terminal unit 2279 while recording is carried out.

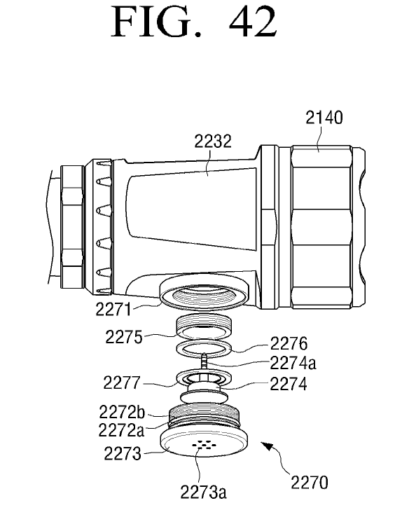

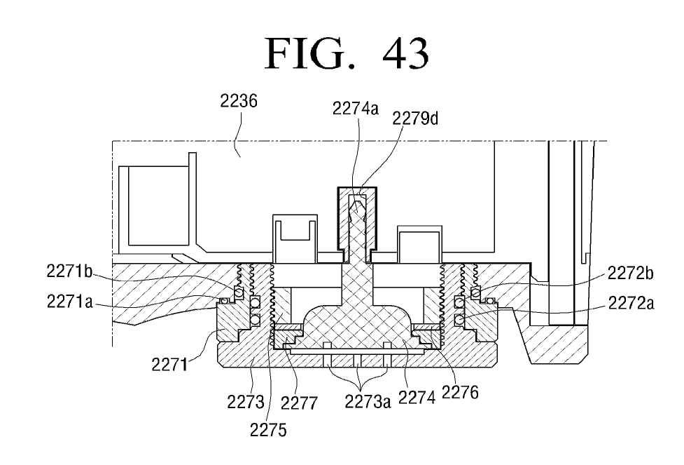

Referring to FIGS. 42 and 43, to record underwater, an independently-fabricated connect terminal 2274a of a waterproof microphone 2274 is inserted into a microphone connect port 2279d of the external connect terminal unit 2279 so that recording is carried out through the waterproof microphone 2274. The waterproof microphone 2274 may be designed to resist 24 m water pressure.

The external connect terminal unit 2279 may additionally include a waterproof structure to maintain airtightness. Such waterproof structure may include a waterproof cap 2273 screw-coupled with the fastening annular frame 2271, a pair of O rings 2272a, 2272b, a sealing 2277 having a stepwise portion, an annular frame 2276 and a fixing annular frame 2275.

The assembling is carried out in the following order. The upper end of the waterproof microphone 2274 is fixed on the waterproof cap 2273, and the sealing 2277 is inserted into the waterproof cap 2273 to a tight contact with the outer circumference of the waterproof microphone 2274 and the inner circumference of the waterproof cap 2273. In such a state, the annular frame 2276 is inserted into the waterproof cap 2273 to contact the sealing 2277, and the waterproof microphone 2274 is fixed airtightly in the fastening annular frame 2271 by screw-coupling the fixing annular frame 2275 inward the waterproof cap 2273. Then the waterproof cap 2273 is screw-coupled with the inner side of the fastening annular frame 2271. The connect terminal 2274a of the waterproof microphone 2274 is automatically connected to the microphone connect port 2279d. The waterproof microphone 2274 includes a plurality of through holes 2273a formed on an upper end through which sound is delivered to the waterproof microphone 2274.

The waterproof cap 2273 is used when the AV flashlight is used at or shallower than 24 m depth of water where the waterproof microphone 2274 can resist water pressure. A separate waterproof cap (not illustrated) having no through hole 2273a may be used for simple waterproof purpose, if the AV flashlight is used between 24 m and 100 m water depth.

Referring back to FIG. 40, the external connect terminal unit 2279 may include a micro SD memory insert port 2279a, a universal serial bus (USB) memory connect terminal 2279b, and a high-definition multimedia interface (HDMI) connect terminal 2279c.

Referring again to FIG. 37, the first lens barrel 2232 may include a first rotary switch SW1 on a rear end thereof. The first rotary switch SW1 may be a contactless magnetic sensor which includes a switch unit 2234 and a sensor unit 2235.

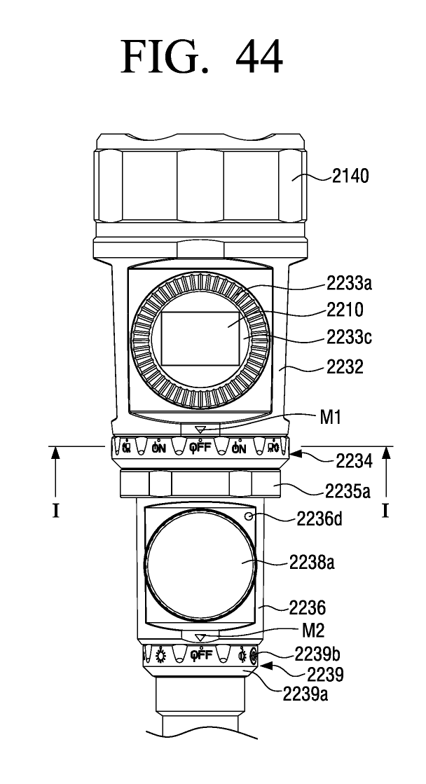

Referring to FIGS. 44 to 47, the switch unit 2234 includes an annular body 2234a, an adjusting bolt 2234b, a ball bearing 2234c, and a guide annular frame 2234e. The annular body 2234a surrounds the guide annular frame 2234e, and rotates in a forward and backward directions along a circumference of the guide annular frame 2234e. The ball bearing 2234c is slidably inserted into a fastening hole 2234j formed in the annular body 2234a, and prevented from separating from the fastening hole 2234j due to the presence of a separation preventing protrusion 2234d. Further, the ball bearing 2234c is pressed by the adjusting bolt 2234b which is screw-coupled to the fastening hole 2234j. The adjusting bolt 2234b may include a hexagonal wrench inserting hole 2234k formed on a head, and may adjust pressing force of the ball bearing 2234c.

The structure for pressing the ball bearing 2234c is formed in a manner such that the ball bearing 2234c is pressed by the elastic force exerted on a pressing plate 2234i due to a compression spring 2234h arranged in an inner recess 2234g of the adjusting bolt 2234b to a direction of the guide annular frame 2234e. In one example, a part of the ball bearing 2234c is inserted into a shallow fixing hole 2234f, so that the annular body 2234a is fixed at a predetermined location (i.e., location at which a hole sensor 2341 and a plurality of magnet chips 2235b face each other).

If the annular body 2234a to change the switch mode is rotated in a forward or backward direction, the ball bearing 2234c is separated from the fixing hole 2234f of the guide annular frame 2234e, and moved onto the outer circumference of the guide annular frame 2234e. After the annular body 2234a is rotated by a predetermined angle, the ball bearing 2234c is inserted into another fixing hole formed in the guide annular frame 2234e. The number of fixing holes 2234f formed in the guide annular frame 2234e may correspond to the number of switches modes. In one embodiment, since two ball bearings 2234c are employed, a plurality of fixing holes may be formed to selectively fix the respective ball bearings 2234c. The switch mode of the first rotary switch SW1 may include, in an order from the left side, night photographing, video camera OFF, video camera ON, video camera OFF, day photographing modes (see FIG. 44).

For convenience of changing switch mode by rotating the annular body 2234a, icons corresponding to the respective switch modes may be marked on the annular body 2234a. Accordingly, a corresponding function is performed if the user sets any icon to a location corresponding to a set location mark M1 indicated on an outer side of the first lens barrel 2232.

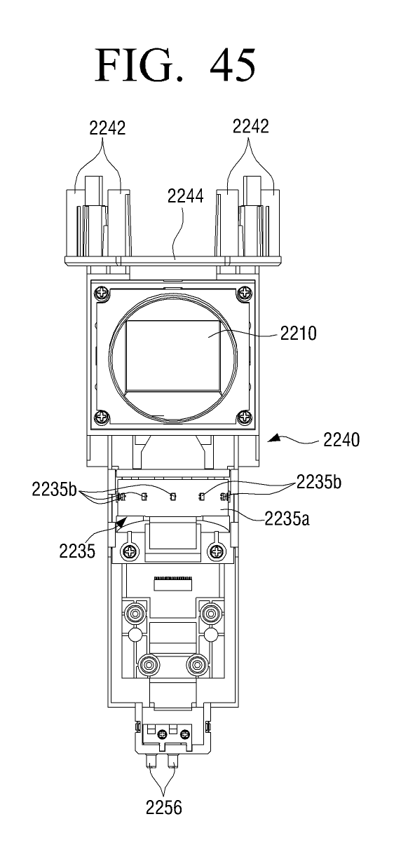

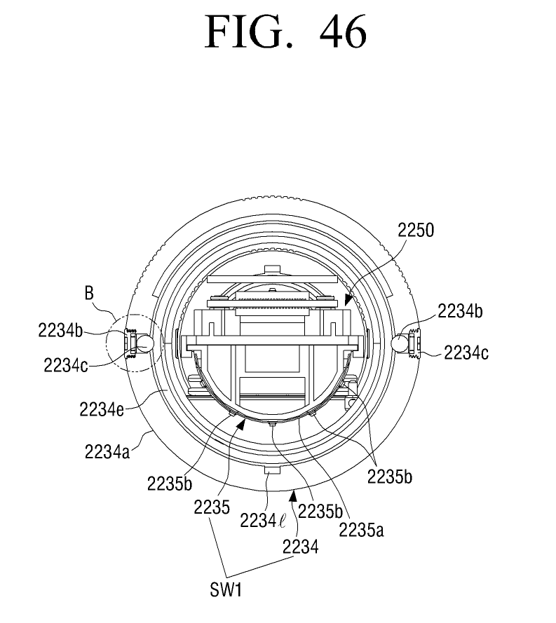

Referring to FIGS. 45 and 46, the sensor unit 2235 includes a semi-spherical round board 2235a (e.g., FPCB) on one side of the board housing 2250, and five magnetic chips 2235b mounted at uniform intervals on the board 2235a. One from among the plurality of magnetic chips 2235b is selected according to the location setting at the hole sensor 2341, and a switch mode corresponding to the selected magnetic chip 2235b is set.

As explained above, the first rotary switch SW1, which is a contactless switch using magnet, does not malfunction even at the 100 m depth of water, and can precisely select a switch mode. The second rotary switch (SW2) which will be explained below operates in the same structure and principle as those of the first rotary switch (SW2).

Referring back to FIG. 37, the window unit 2233 is 100 m high water pressure resistant, and is structured to waterproof the image display module 2210 and also increase the degree of pressure resistance. The window unit 2233 is installed on the first mounting hole 2232d of the first lens barrel 2232.

Further, the window unit 2233 may include, in an order from the upper direction, a ring-type fastening nut 2233a, an O ring 2233b, a transparent lens 2233c, O rings 2233d, 2233e, an annular frame 2233f and a fixing annular frame 2233g. In assembling the window unit 2233, the O ring 2233b is inserted into a rear end of the locking protrusion formed along an inner circumference of the fixing nut 2233a, the transparent lens 2233c and the annular frame 2233f are placed in order on the O ring 2142, and the fixing annular frame 2233g is fastened in screw manner to firmly press-fit the transparent lens 2233c onto the locking protrusion of the fixing nut 2233a. Additionally, the pair of O rings 2233d, 2233e are fastened to the screw threads on the outer circumference of the fixing nut 2233a, to thereby ensure airtightness between the fixing nut 2233a and the first lens barrel 2232. As a result, by the use of the O rings 2233b, 2233d, 2233e, airtightness between the window unit 2233 and the first lens barrel 2232 is ensured.

Further, since the ring-type fastening nut 2233a takes a circular form which has a large enough diameter to surround the rectangular LCD of the image display module 2210, the angle of view of the LCD is ensured.

The second lens barrel 2236 may be tapered in which the outer diameter gradually decreases in a direction from leading to rear ends. The second lens barrel 2236 may include a locking protrusion 2236a formed on an outer circumference of the leading end, and an inner rear end of the fixing nut 2235a is locked with the locking protrusion 2236a. An outer diameter of the leading end of the second lens barrel 2236 is smaller than the inner diameter of the rear end, so that the leading end of the second lens barrel 2236 is inserted in the first lens barrel, and the rear end of the first lens barrel 2232 is locked with the locking protrusion 2236a. Accordingly, by the screw-coupling of the fixing nut 2236a with the screw thread 2232c of the first lens barrel 2232, the second lens barrel 2236 is engaged with the rear end of the first lens barrel 2232. The O rings 2235b, 2235c are interposed on the connecting portion between the first and second lens barrels 2232, 2236.

Aligning holes (not illustrated) with centers aligned with each other may be formed on the facing and contacting surfaces of the first and second lens barrels 2232, 2236. The aligning pins 2233 are inserted into the aligning holes to thus align the horizontal position of the first and second lens barrels 2232, 2236. That is, in a state that the aligning pin 2233 is fixed in the aligning hole of the first lens barrel 2232, the aligning pin 2233 is inserted into the aligning hole of the second lens barrel 2236 so that the first mounting hole 2232d of the first lens barrel 2232 and the mounting hole 2236c of the second lens barrel 2236 are arranged in a line.

A second mounting hole 2236c is formed on an outer circumference of the second lens barrel 2236, and the keypad module 2220 is mounted inside the second mounting hole 2236c.

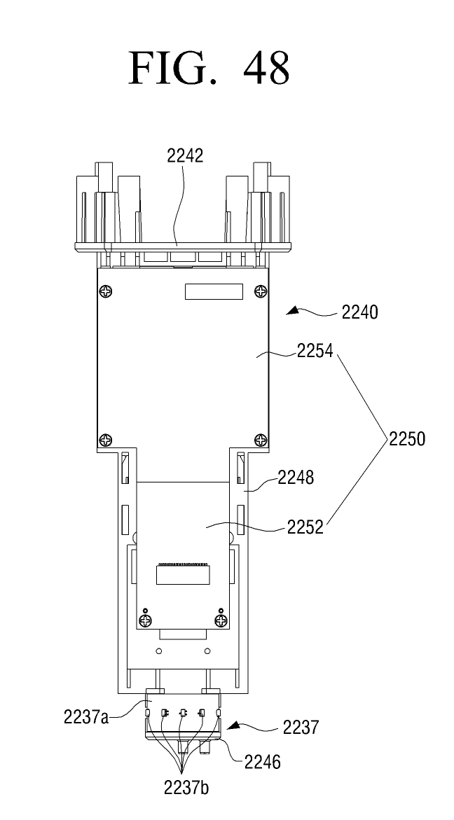

A screw thread 2236b is formed on the outer circumference of the rear end of the second lens barrel 2236. The leading end of the rear portion 2300 is screw-coupled with the screw thread 2236b. The O ring 2237 is interposed on a connecting portion between the second lens barrel 2236 and the rear portion 2300. The second rotary switch (SW2) is formed on the rear end of the second lens barrel 2236. Like the first rotary switch (SW1), the second rotary switch (SW2) is a contactless magnetic sensor which includes a switch unit 2239 and a sensor unit 2237 (see FIG. 48). The second rotary switch (SW2) controls lighting, and includes lighting on/off, brightness adjustment and SOS signal as switch modes. Since the structure of the second rotary switch (SW2) is identical to that of the first rotary switch (SW1), this will not be explained in greater detail for the sake of brevity. Referring to FIG. 37, a reference numeral 2239a denotes a rotary body, 2239b is an adjustment bolt, and 2239c is a ball bearing. Referring to FIG. 48, a reference numeral 2237a is a board (e.g., FPCBG), and 2237b is a magnetic chip.

In one embodiment, the lens barrel portion 2230 may have a first lens barrel 2232 and a second lens barrel 2236 divided from each other. However, in other embodiment including the second embodiment explained above, the first and second lens barrels 2232, 2236 may be integrally formed with each other. The first and second mounting holes are arranged in a line along a central line on the outer circumference of such integrated lens barrel.

The board housing 2240 is a box-type housing with an open upper portion, which includes a front 2244, a rear plate 2246, and a supporting plate 2248 to connect the front and rear plates 1244, 1246. The board housing 1240 may be formed by plastic injection molding. Accordingly, the board housing 2240 is slid into and accommodated in the interior of the lens barrel portion 2230.

The front plate 2244 is surface-contacted with the inner sidewall of the connecting portion 2232b of the first lens barrel 2232 and fixed in place by the screw (not illustrated). An engaging means, which is engaged with the head portion 2100, is formed on the front surface of the front plate 2244. That is, a plurality of supporting bars 2242 are formed on the front surface of the front plate 2244 at predetermined distance from each other and extend to the front direction. One end of the supporting bar 2242 is firmly fit with a bushing protruding in a forward direction from the front plate 2244. The other end of the supporting bar 2242 is firmly inserted in the through hole (not illustrated) of the head housing 2156. Likewise, the through hole (not illustrated) of the head housing 2156 refers to the through hole that passes through the bushing protruding in a rear direction. The idea of the supporting bar 2242 is to firmly fix the head portion 2100 on the body portion 2200 with a metal bar. A cable hole, jack or connector may be installed or mounted on the front plate 2244. That is, connecting means to supply electrical signal and power to the respective components may be provided.

The rear plate 2246, which may take a semi-circular configuration, is extended through the interior space and arranged on a rear end of the second lens barrel 2236. A terminal unit 2256 to be electrically contacted with the battery module protrudes from the rear plate 2246 to a rear direction, thus forming an elastic contact point. Further, the sensor unit 2237 of the second rotary switch (SW2) is formed on the outer circumference of the rear plate 2246.

A circuit board is fixed on top of the supporting plate 2248. The width of the portion of the supporting plate 2248, which is arranged in the interior space of the first lens barrel 2232, is wider than the width of the portion arranged in the interior space of the second lens barrel 1236. The circuit board 2250 includes a lower board 2252, i.e., a power control board, and an upper board 2254, i.e., a main control board.

The lower board 2252 has the same length as the full length of the board housing 2240 and fixed on the supporting plate 2248 of the board housing 2240. The upper board 2254 is arranged on the lower board 2252, with four corners fixed by the screws on four upwardly protruding support columns of the supporting plate 2248.

A connector to connect to the keypad module 2220 is provided on top of a location that corresponds to the opening 2236c of the second mounting hole 2236c. The micro SD memory insert port 2279a, USB memory connect terminal 2279b, and HDMI connect terminal 2279c of the external connect terminal unit 2279 are connected at a location on the lower surface of the lower board 2252 that faces a plurality of through holes (not illustrated).

The lower board 2252 is connected to a cable to supply electricity to the visible light source module 2120 and the infrared light source module 2130 of the head portion 2100. The lower board 2252, the keypad module 2220 and the GPS module 2222 are connected to each other via flexible cable.

The upper board 2254 is electrically connected to the lower board 2252, and mounts thereon a micro processor chip or a memory chip to control the system. The upper board 2254 is connected to a cable to supply a control signal to the image display module 2210, the video camera module 2110 and the audio module 2260 and receive an input signal. The keypad module 2220 is connected to the upper board 2254 via the lower board 2252. The upper board 2254, the image display module 2210 and the video camera module 2110 are connected to each other via flexible cables.

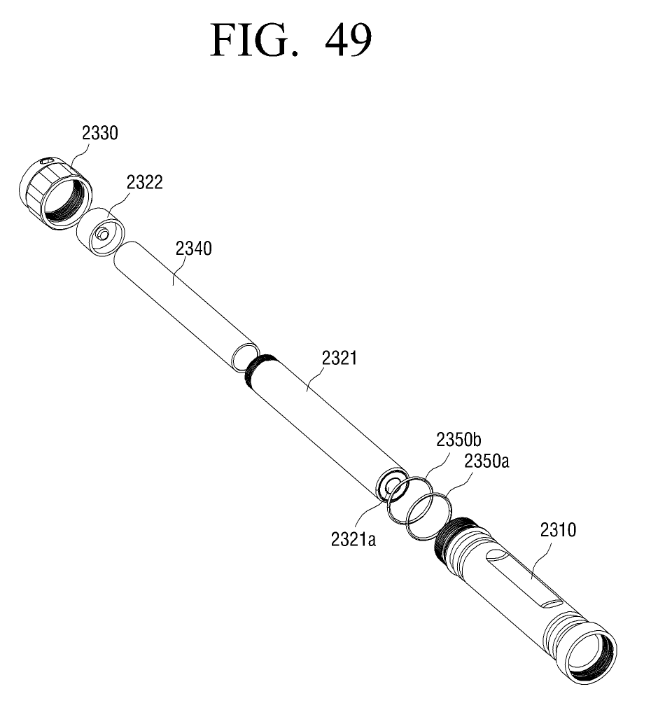

Referring to FIG. 49, the rear portion 2300 includes a rear lens barrel 2310, a battery housing 2321, a housing cap 2322, a rear cap 2330, a battery 2340, and O rings 2350a, 2350b. A single rechargeable battery 2340 is removably inserted in the battery housing 2321, and a central copper disc to be connected to the terminal unit 2256 and a copper hook plate arranged around the central copper disc are formed on the leading end surface 2321a of the battery housing 2321. The O rings 2350a, 2350b are interposed between the rear end and the rear cap 2330 of the rear lens barrel 2310 to seal the rear lens barrel 2310. The housing cap 2322 is removably attached to a rear end of the battery housing 2321 and connected to a negative pole of the battery 2340.

The battery 2340 may implement the battery 1340 according to the second embodiment.

The AC flashlight constructed as explained according to the third embodiment may be used in the following manner.

In an example where the AV flashlight is used under water and thus needs waterproof function, the user may control the photographing and the content displayed on the LCD of the image display module 2210 using the first rotary switch (SW1), and also control lighting using the second rotary switch (SW2). Since the AV flashlight according to the embodiment are water resistant at or below 10 m water depth, it is possible to photograph and record sound with lighting, even in rains, or under river or sea.

Of course, the first and second rotary switches (SW1, SW2) may also be used outside the water where waterproof function is unnecessary. Also, outside the water, the user may control the AV flash camera 10 using the keypad module 2220. Although not illustrated, depending on needs, the video camera may be turned on to display the video on the image display module 2210, along with a key to record predetermined video, or a key to record sound.

Accordingly, by turning on/off the visible light source 2120 using the second rotary switch (SW2) or the keypad module 2220, the user is able to use the original function of the AV flashlight.

The user is also able to take videos by manipulating the video camera 2110 using the first rotary switch (SW1) (or keypad module 2220) and the image display module. At night, the user may turn on the infrared light source module 2130 with the first rotary switch (SW1) (or keypad module 1220), operate the video camera module 110 and take a video shot. Further, if necessary, the user may record sound by manipulating the microphone module 2260 with the keypad module 2220. Also, the waterproof speaker 2274 may be used under water to record sound.

The foregoing exemplary embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A portable audio and video (AV) flashlight comprising a head portion, a body portion, and a rear portion, the portable AV flashlight comprising:
a video camera module incorporating therein a visible light source and an infrared light source mounted on the head portion;
a GPS module mounted on the body portion;
an electronic compass module mounted on the body portion;
a display module mounted on an outer surface of the body portion to display an image;
a map database module mounted on the body portion to store map information; and
a control module mounted on the body portion to read the map information from the map database within a predetermined angle range with reference to an azimuth angle detected through the electronic compass module, display the read map information on the display module, and on-screen display current location information and location information of one or more main objects in a forward direction from the current location, and linear distance information between the current location information and the location information of one or more main objects.

2. The portable AV flashlight of claim 1, wherein the control module comprises:
a location information calculating unit to calculate current location information in response to GPS information provided from the GPS module;
an azimuth angle information calculating unit to calculate current azimuth angle information in response to earth magnetic field sensing information provided from the electronic compass;
a search window generating unit to generate a equilateral triangular search window within a predetermined angle range of a left side and a right side with reference to a direction of the azimuth angle in response to the calculated azimuth angle information;
an object search unit to search object information registered in the generated equilateral triangular search window by accessing the map database, and read out the searched location information of at least one object;
a distance calculating unit to calculate the distance information between the read location information of the at least one object and the current location information; and
an on-screen display to provide the calculated linear distance information and the read location information of the at least one object as on-screen data to the display module.

3. The portable AV flashlight of claim 2, wherein the control module comprises:
a patrol track generating unit to generate a patrol track in response to the calculated current location information; and
a patrol information generating unit to generate a range and a direction of patrol in combination with the equilateral triangular search windows generated along the generated patrol track.

4. The portable AV flashlight of claim 1, wherein the video camera module has a Full HD resolution.

5. The portable AV flashlight of claim 1, wherein the video camera module comprises an infrared shutter to be operated automatically in an infrared photographing mode.

6. The portable AV flashlight of claim 1, wherein the control module compresses Full HD image data captured through the video camera module in H-264/MPEG4 compression and records and stores the compressed data.

7. The portable AV flashlight of claim 1, wherein the visible light source comprises high brightness LED diodes having 150 Lm to 450 Lm brightness, and the control module comprises a visible light source driving unit to adjust the brightness of the high brightness LED diodes into three stages, which are 30%, 50% and 100%.

8. The portable AV flashlight of claim 1, wherein the control module comprises an image data input and output connector on an outer circumference of the body portion.

9. The portable AV flashlight of claim 1, wherein the control module comprises an extendable external memory connector on an outer circumference of the body portion.

10. The portable AV flashlight of claim 1, wherein the GPS module comprises a GPS antenna which is arranged on a keypad area mounted on an outer surface of the body portion.

11. The portable AV flashlight of claim 1, further comprising a memory card removably attached to the body portion to store video and location information, wherein the control module stores the video information captured through the video camera module along a path of travel, and stores to the memory card the location information, time information and distance information of a starting point, one or more section points, and finishing point of the path of travel in association with the video information.

12. The portable AV flashlight of claim 1, wherein the body portion comprises:
a lens barrel portion comprising a keypad module mounted thereon, and a first mounting hole and a second mounting hole arranged in a central line direction on an outer circumference so that the display module is mounted on the first mounting hole and the keypad module is mounted on the second mounting hole, the lens barrel portion in which a rear end of the head portion is screw-coupled with a leading end, and a leading end of the rear portion is screw-coupled with a tail portion;
a board housing slidingly inserted from a leading end of the lens barrel portion to be accommodated in an interior space of the lens barrel portion, and comprising a coupling means formed on a leading end surface to be coupled with the head portion, and a terminal portion formed on a rear end surface to be electrically contacted with a battery module received in the tail portion; and
a circuit board fixed on the board housing and on which a control circuit mounted n which the control circuit connected electrically to an image display module if mounted, through an opening formed in bottom of the first mounting hole, connected electrically to the battery module through the terminal portion, connected to the keypad module through an opening formed in a bottom of the second mounting hole, and connected to a video came a module, a visible light source module and an infrared light source module of the head portion to control the respective modules.

13. The portable AV flashlight of claim 12, wherein the lens barrel portion comprises:
a first lens barrel portion comprising the first mounting hole formed on an outer circumference and a leading end screw-coupled with a rear end of the head portion; and
a second lens barrel portion comprising the second mounting hole formed on an outer circumference, a leading end inserted into the first lens barrel portion, and a rear end screw-coupled with a leading end of the tail portion.

14. The portable AV flashlight of claim 13, wherein the first and the second lens barrel portions are connected to each other by a screw-coupling of a nut rotatably mounted on an outer circumference of one side end and a screw thread formed on an outer circumference of another side end.

15. The portable AV flashlight of claim 14, wherein an aligning means if formed on a connecting surface between the first and the second lens barrel portions to align horizontal arrangement.

16. The portable AV flashlight of claim 15, wherein the aligning means comprise aligning pins which, at a vertically upward direction from the central line of the first and the second lens barrel portions, have a central line aligned with a rear end surface of the first lens barrel portion and a leading end surface of the second lens barrel portion which are surface-contacted with each other if assembled, inserted in between recesses which have open portions facing each other.

17. The portable AV flashlight of claim 12, wherein the first lens barrel portion further comprises in an inner cross section thereof at least one through hole extending through an upper sidewall of the first mounting hole, and a microphone module facing the at least one through hole and mounted on the inner cross section.

18. The portable AV flashlight of claim 17, wherein the microphone module comprises:
an O ring mounted on an annular hole which surrounds the at least one through hole;
a microphone, with an edge covering the O ring, to pick up a sound wave under water; and
a metal plate which has an opening to which a rear protruding portion of the microphone is inserted, and fixed to the inner cross section by screw-coupling.

19. The portable AV flashlight of claim 12, comprising, on an outer circumference of the first lens barrel portion opposite to the first mounting hole, at least one cylindrical opening and at least one screw-type cap to cover the at least one cylindrical opening, and
on a bottom surface of the board housing which is located directly upward direction from the at least one cylindrical opening, at least one external connect terminal portion electrically connected to the circuit board.

20. The portable AV flashlight of claim 19, wherein the at least one external connect terminal portion comprises at least one of USB jack, JDMI jack, or flash memory socket.

21. The portable AV flashlight of claim 19, wherein one of the at least one cap has a screw hole for engagement with a camera tripod.

22. The portable AV flashlight of claim 12, wherein the coupling means comprises:
at least one bushing protruding from the leading end surface; and
a supporting bar, with one end fixedly inserted in the bushing, extending toward the head portion.

23. The portable AV flashlight of claim 12, wherein the image display module comprises:
a flexible cable having one end connected to the circuit board which is exposed through the opening of the first mounting hole and the other end withdrawn in an upward direction;
a liquid crystal panel arranged on the opening of the first mounting hole and connected to the other end of the flexible cable, the liquid crystal panel having a rubber-coated edge;
a square rubber ring inserted in a sealing groove around the opening;
a transparent plate to cover the liquid crystal panel and the square rubber ring;
a metal plate arranged on the transparent plate and having an opening at a center, the metal plate fixed to a bottom of the first mounting hole by screw-coupling; and
an external film having a transparent window at a center and attached to the metal plate.

24. The portable AV flashlight of claim 23, wherein the transparent plate has the same size as the metal plate, and a protruding portion formed at a center to be inserted in the opening of the metal plate.

25. The portable AV flashlight of claim 12, wherein the keypad module comprises:
a flexible cable with one end connected to the circuit board which is exposed through the opening of the second mounting hole and the other end withdrawn in an upward direction;
a keypad board arranged on the opening of the second mounting hole to be connected to the other end of the flexible cable;
a square rubber plate having a protruded annular frame on a lower surface to be inserted around a sealing groove around the opening, and a plurality of pressing protrusions formed to correspond to keypad of the keypad board;
a metal plate which has an opening formed at a center, uniformly press-fits the edge of the square rubber plate and which is fixed on a bottom of the second mounting hole by screw-coupling; and
an external film which has a key configuration printed at a location corresponding to the plurality of pressing protrusions and which is attached to the metal plate.

26. The portable AV flashlight of claim 25, wherein the keypad board has a GPS module mounted at a center, with a plurality of keypads arranged therearound.

27. The portable AV flashlight of claim 12, wherein the circuit board comprises:
a power control board which has a length corresponding to a length measured from a rear end to a leading end of the board housing, and which converts an electric voltage supplied from a battery module connected through the terminal portion into a necessary voltage for each module and control the keypad module, the visible light source module and the infrared light source module; and
a main control board which has a length corresponding to a length measured from a leading end to a rear end of the first lens barrel portion, arranged on the power control board, and controls the power control board, the image display module and the video camera module.

28. The portable AV flashlight of claim 12, wherein the head portion comprises:
a head lens barrel;
a head housing which is coupled with the coupling means and arranged within the head lens barrel, and comprises a video camera mounting hole formed on an upper direction of affront surface, a visible light source mounting hole formed on a lower direction of the front surface, and a plurality of infrared light source mounting holes arranged laterally between the video camera mounting hole and the visible light source mounting hole;
a video camera module which is fixedly mounted on the video camera mounting hole and which includes an infrared shift cut shutter;
an infrared light source module which is mounted on the plurality of infrared light source mounting holes and which includes a plurality of stationary infrared light emitting diodes; and
a high brightness white light emitting diode which is fixedly mounted on the visible light source mounting hole.

29. The portable AV flashlight of claim 28, wherein the infrared light source module comprises:
a right board and a left board which are respectively extended along the plurality of laterally-arranged infrared light source mounting holes and screw-coupled to a rear surface of the head housing;
a first group of the plurality of infrared light emitting diodes formed on the right board and mounted the infrared light source mounting holes arranged on the right side; and
a second group of the plurality of infrared light emitting diodes formed on the left board and mounted on the infrared light source mounting holes arranged on the left side.

30. The portable AV flashlight of claim 28, wherein the visible light source module comprises:
an aspheric collimating lens coupled to the visible light source mounting hole;
a white light emitting diode optically coupled to a rear end of the aspheric collimating lens; and
a heat dissipating cover which is screw-coupled to a rear surface of the head housing, covering the aspheric collimating lens and the white light emitting diode board, and which is surface-contacted with a rear surface of the white light emitting diode board to dissipate heat.

31. The portable AV flashlight of claim 30, wherein one side surface of the heat dissipating cover has a curved surface contacted with an inner side surface of the head lens barrel, and a heat dissipating pin on the rest outer surface.

32. The portable AV flashlight of claim 28, wherein the head portion comprises:
an O ring mounted on an inner leading end of the head lens barrel;
a transparent lens covering the O ring inside the head lens barrel;
a surface protective annular frame covering a lens edge; and
a lens fixing annular frame which is screw-coupled to a screw thread formed on the inner circumference of the head lens barrel to press-fit the transparent lens to the inner leading end of the head lens barrel.

33. The portable AV flashlight of claim 12, wherein the tail portion comprises:
a rear lens barrel;
a batter housing inserted into the rear lens bane;
a secondary lens barrel extendably connected to a rear end of the rear lens barrel;
a secondary battery housing which is inserted into the secondary lens barrel and has a terminal portion formed on a leading end to be connected electrically to rear end terminals of the battery housing; and
a secondary tail end cap to cover a rear end of the secondary lens barrel.

34. The portable AV flashlight of claim 12, wherein the body portion further comprises a window unit which is screw-coupled to the first mounting hole to enable checking of the image on the image display module and is waterproof and resistant against water pressure.

35. The portable AV flashlight of claim 34, wherein the window unit comprises:
a ring-type fastening nut screw-coupled to the first mounting hole;
a transparent lens inserted into the fastening nut;
a fixing annular frame screw-coupled into the fastening nut to fix the transparent lens on the fastening nut; and
at least one O ring interposed between the ring-type fastening nut and the first mounting hole.

36. The portable AV flashlight of claim 12, wherein the first lens barrel comprises a first rotary switch formed on a rear end to control photographing, and a second rotary switch formed on a rear end of the second lens barrel to control lighting, and
the first and the second rotary switches are contactless magnetic type rotary switches.

37. The portable AV flashlight of claim 36, wherein the first rotary switch is rotatably formed on a rear end of the first lens barrel portion and comprises an annular switch to set switch mode, and a sensor unit formed on the board housing with a curvature corresponding to that of the annular switch portion to respond to the set location of the annular switch portion, and
the second rotary switch is rotatably formed on a rear end of the second lens barrel portion and comprises an annular switch portion to set switch mode, and a sensor unit formed on the board housing with a curvature corresponding to that of the annular switch portion to respond to the set location of the annular switch portion.

38. The portable AV flashlight of claim 12, further comprising an internal microphone module formed on an inner cross section of the first lens barrel portion, and a waterproof speaker to connect to the internal microphone module.

39. The portable AV flashlight of claim 38, wherein the waterproof speaker is removably connected to a microphone connect port provided in the first lens barrel portion, and sound is recorded through a plurality of through holes of a waterproof cap in a state that waterproof is maintained due to the waterproof cap which is screw-coupled to a fastening annular frame of the first lens barrel that surrounds the microphone connect port.

40. The portable AV flashlight of claim 23, the GPS receiving module is arranged in a non-sunken state on the second lens barrel to prevent interference of a GPS signal received from a satellite.

41. The portable AV flashlight of claim 25, comprising a metal cap airtightly screw-coupled to the first lens barrel to cover the keypad module and the GPS receiving module.

42. The portable AV flashlight of claim 41, further comprising a plastic cap to be connected to the first lens barrel to cover the keypad module and the GPS receiving module after the metal cap is separated from the first lens barrel.

43. The portable AV flashlight of claim 12, wherein the head portion comprises:
a head lens barrel; and
a head housing which is connected to the coupling means and arranged within the head lens barrel, and comprises a video camera located at an upper direction of a front surface, a visible light source located at a lower direction of the front surface, and a plurality of infrared light sources arranged laterally between the video camera and the visible light source, wherein
the plurality of infrared light sources are arranged in proximity to the video camera.

44. The portable AV flashlight of claim 43, comprising a heat dissipating cover fixed to a rear surface of the head housing to dissipate heat while being surface-contacted with a rear surface of the visible light source board, wherein
one side surface of the heat dissipating cover has a curved surface to be connected with an inner side surface of the head lens barrel, while a dissipating pin is formed on the rest outer surface.

45. The portable AV flashlight of claim 12, wherein the tail portion comprises:
a rear lens barrel;
a battery housing inserted in the rear lens barrel;
a housing cap connected to a rear end of the battery housing to be connected to a negative pole of a battery inserted in the battery housing; and
a rear cap covering a rear end of the rear lens barrel.

46. A method for displaying video stored in a memory card and location information along a path of travel applied in taking the video on a monitor, the method comprising:
reading out photographed video information and location information related to the video information from the memory card;
displaying the read video information on a part of the monitor, while concurrently displaying a map screen based on the location information related to the video on the rest screen of the monitor; and
displaying a path corresponding to the path of travel applied in taking the video on the map screen in association with a time of replaying the video information, wherein
the paths are divided into a starting point, section points, and a finishing point and indicated on the map screen with balloon pins in different colors, and
if one site around one of the starting point, the section points or the finishing point is designated, a distance to the designated site is displayed.

47. The method of claim 46, wherein the designated site is indicated by a balloon pin in a different color from the balloon pins that indicate the starting point, the section points or the finishing point.

48. The method of claim 46, wherein the designated site is stored together as updated information of the video information and the location information related to the video.
